(19) United States
(12) Patent Application Publication
(10) Pub. No.: US 2010/0315431 A1
(43) Pub. Date: Dec. 16, 2010

(54) COMBINING OVERLAPPING OBJECTS

(75) Inventors: David Christopher Smith, Bridgewater (AU); Alexander Will, Randwick (AU); Cuong Hung Robert Cao, Revesby (AU)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, TOKYO (JP)

(21) Appl. No.: 12/813,780

(22) Filed: Jun. 11, 2010

(30) Foreign Application Priority Data
Jun. 15, 2009 (AU) 2009202377

(51) Int. Cl. G09G 5/00

(52) U.S. Cl. 345/619

(57) ABSTRACT

A method of modifying drawing commands to be input to a rendering process is disclosed. The method detects a first glyph drawing command and detects a predetermined number of further glyph drawing commands proximate within a threshold of the first glyph drawing command. The predetermined number of proximate glyph drawing commands is accumulated. The accumulated proximate glyph drawing commands are combined into a 1-bit depth bitmap. The 1-bit depth bitmap is output to the rendering process as a new drawing command.

### REFERENCE TO RELATED PATENT APPLICATION

This application claims the benefit under 35 U.S.C. §119 of the filing date of Australian Patent Application No. 2009202377, filed Jun. 15, 2009, hereby incorporated by reference in its entirety as if fully set forth herein.

### TECHNICAL FIELD

The current invention relates to graphics processing and, in particular, to graphics processing optimisations in the rendering pipeline, including the data stream input to the rendering process.

### BACKGROUND

In modern operating systems, in order to print data, the data to be printed needs to travel through several stages in a printing pipeline. At each stage, a processing module may manipulate the data before passing the data on to the next stage in the pipeline. Typically, an application will print a document by invoking operating system drawing functions. The operating system will typically convert the drawing functions to a known standardized file format such as PDF or XPS, spool the file, and pass the spooled file on to a printer driver. The printer driver will typically contain an interpreter module which parses the known format, and translates the known format to a sequence of drawing instructions understood by a rendering engine module of the printer driver. The printer driver rendering engine module will typically render the drawing instructions to pixels, and pass the pixels over to a backend module. The backend module will then communicate the pixels to the printer.

It can therefore be seen that such a system is highly modularised. Typically, modules in the printing pipeline communicate with each other through well defined interfaces. This architecture facilitates a printing pipeline where different modules are written by different vendors, and therefore promotes interoperability and competition in the industry. A disadvantage of this architecture is that modules in the pipeline are loosely coupled, and therefore one module may drive a second module in the printing pipeline in a manner that is inefficient for that second module.

It is therefore recognised in the art that there is a need for an idiom recognition module, typically situated between the printer driver interpreter module, and the printer driver rendering engine module. The role of the idiom recognition module is to simplify and re-arrange the drawing instructions issued by the printer driver interpreter module to make the drawing instructions more efficient for the printer driver rendering engine module to process.

Typically a computer application or an operating system provides graphic object stream to a device for printing and/or display. A graphic object stream is a sequence graphic objects arranged in a display priority order (also known as z-order). A typical graphic object is used to describe a glyph or graphic object which comprises of a fill path, a fill pattern, a raster operator (ROP), and optional clip paths, and other attributes.

For example the application may provide a graphic object stream via function calls to a graphics device interface (GDI) layer, such as the Microsoft Windows™ GDI layer. The printer driver for the associated target printer is the software that receives the graphic object stream from the GDI layer. For each graphic object, the printer driver is responsible for generating a description of the graphic object in the page description language that is understood by the rendering system of the target printer.

In some systems the application or operating system may store the application's print data in a file in some common well-defined format. The common well-defined format is also called the spool file format. During printing, the printer driver receives the spool file, parses the contents of the file to generate graphic object streams for the Raster Image Processor on the target printer. Examples of spool file formats are Adobe's PDF™ and Microsoft's XPS™.

In order to print a spool file residing on a host computer on a target printer, the spool file contents must first be converted to an equivalent graphic object stream for processing by a Raster Image Processor (RIP). A filter module typically residing in a printer driver is used to achieve this conversion. The RIP renders the graphic object stream into pixel data for reproduction.

Most raster image processors (RIPs) utilize a large volume of memory, known as a frame store or a page buffer, to hold a pixel-based image data representation of the page or screen for subsequent reproduction by printing and/or display. Typically, the outlines of the graphic objects are calculated, filled with colour values and written into the frame store. For two-dimensional graphics, graphic objects that appear in front of other graphic objects are simply written into the frame store after the background graphic objects, thereby replacing the background on a pixel by pixel basis. This approach to rendering is commonly known as “Painter's algorithm”. Graphic objects are considered in rendering order, from the rearmost graphic object to the foremost graphic object, and typically, each graphic object is rasterized in scanline order and pixels are written to the frame store in sequential runs along each scanline. These sequential runs are termed “pixel runs”. Some RIPs allow graphic objects to be composited with other graphic objects in some way. For example, a logical or arithmetic operation can be specified and performed between one or more graphic objects and the already rendered pixels in the frame buffer. In these cases, the rendering principle remains the same: graphic objects are rasterized in scanline order, and the result of the specified operation is calculated and written to the frame store in sequential runs along each scanline.

Other RIPs may utilise a pixel-sequential rendering approach to remove, or at least obviate, the need for a frame store. In these systems, each pixel is generated in raster order. All graphic objects to be drawn are retained in a display list. On each scanline, the edges of objects, which intersect the scanline, are held in increasing order of their intersection with the scanline. These points of intersection, or edge crossings, are considered in turn, and activate or deactivate objects in the display list. Between each pair of edges considered, the colour data for each pixel which lies between the first edge and the second edge is generated based on which graphic objects are active for that span of pixels. In preparation for the next scanline, the coordinate of intersection of each edge is updated in accordance with the nature of each edge, and the edges are sorted into increasing order of intersection with that scanline. Any new edges are also merged into the list of edges, which is called the active edge list.

Graphics systems which use pixel sequential rendering have significant advantages in that there is no frame store or line store and no unnecessary over-painting during the rendering and compositing operations. Henceforth, any mention or discussion of a RIP in this patent specification, unless expressly stated otherwise, is to be interpreted as a reference to a RIP which uses pixel sequential rendering.

Generally computer applications or operating systems generate optimal graphic objects for displaying or printing. There are some known applications that generate un-optimal graphic objects that cause a RIP to stall or fail to render a certain data stream. This may occur, for example, when thousands of glyph graphic objects are drawn at the approximately the same location. In such a case, there will be many edges and many object activation and deactivation events that will significantly reduce the overall RIP performance. Hence the RIP has difficulty in adequately handling this type of graphic object stream.

In some systems, the whole graphic object stream is analysed to identify regions which have both overlapping glyphs and bitmap graphic objects. The regions which have overlapping glyphs and bitmap graphic objects are then replaced with colour bitmap graphic objects where the colour bitmaps are created by rasterizing the corresponding overlapping regions. This approach indirectly solves the problem at the area where many overlapping glyphs and bitmap graphic object present. However it doesn't address the problem in those areas where there are many overlapping glyphs but there is no bitmap graphic object.

When a computer application provides data to a device for printing and/or display, an intermediate description of the page is often given to device driver software in a page description language. The intermediate description of the page includes descriptions of the graphic objects to be rendered. This contrasts with some arrangements where raster image data is generated directly by the application and transmitted for printing or display. Examples of page description languages include Canon's LIPS™ and Hewlett-Packard's PCL™.

Equivalently, the application may provide a set of descriptions of graphic objects via function calls to a graphics device interface (GDI) layer, such as the Microsoft Windows™ GDI layer. The printer driver for the associated target printer is the software that receives the graphic object descriptions from the GDI layer. For each graphic object, the printer driver is responsible for generating a description of the graphic object in the page description language that is understood by the rendering system of the target printer.

As noted above, the application or operating system may store the application's print data in a file in a spool file format. During printing, the printer driver receives the spool file, parses the contents of the file and generates a description of the parsed data into an equivalent format which is in the page description language (PDL) that is understood by the rendering system of the target printer.

Until recently the functionality of the spool file format has closely matched the functionality of the printer's page description language. Recently, spool file formats have been produced which contain graphics functionality that is far more complex than that supported by legacy page description languages. In particular some PDL formats only support a small subset of the spool-file functionality.

Although PDL formats and print rendering systems are changing to match the new functionality, there exists the problem that many legacy applications continue to be used and archived documents generated by legacy applications continue to be printed, both of which are unable to utilize the new functionality provided by the next generation spool file formats. Such legacy documents naturally require timely and efficient response from the latest model printers which have updated print rendering systems geared for the new functionality of the next generation spool file formats.

For example, a page from a typical business office document in a new spool file format may contain anywhere from several hundred graphic objects to several thousand graphic objects. The same document created from a legacy application, may contain more than several hundred thousand graphic objects.

A rendering system optimized for standard office documents consisting of a few thousand graphic objects may fail to render such pages in a timely fashion. This is because such rendering systems are typically geared to handle smaller numbers of highly functional graphic objects.

In some systems, methods to combine the graphic objects to create a more complex but visually equivalent graphic object have been utilized. But such methods fail to cope with graphic objects of arbitrary shape and position on the page.

In other systems, the graphic objects enter the print rendering system and are added to a display list. As more graphic objects are added, the print rendering system may decide to render a group of graphic objects into an image, which may be compressed. The objects are then removed from the display list and replaced with the image. Although such methods solve the problem of memory, they fail to address the issue of time to print, since the objects have already entered the print rendering system.

### SUMMARY

Disclosed is a graphics rendering system, having a method of applying idiom recognition processing to incoming graphics objects, where idiom recognition processing is carried out using a processing pipeline, the pipeline having a object-combine operator and a group-removal operator, where the object-combine operator is earlier in the pipeline than the group-removal operator, the method comprising:

(i) receiving a sequence of graphics commands comprising of a group start instruction, a first paint object instruction, and a group end instruction;

(ii) modifying the processing pipeline in response to detecting a property of the sequence of graphics commands by relocating the group-removal operator to be earlier in the pipeline stage than the object-combine operator; and

(iii) processing the received first paint object instruction according to the modified processing pipeline.

Also disclosed is the merging of overlapping glyphs by the detection of a sequence of at least a predetermined number (N) overlapping glyph graphic objects in the graphic object stream. The overlapping glyph graphic objects from the predetermined Nth overlapping glyph graphic object to the last overlapping glyph graphic object of the detected sequence are combined into a 1-bit depth bitmap mask. The merging replaces the detected overlapping glyph graphic objects from the predetermined Nth overlapping glyph graphic object to the last detected overlapping glyph graphic object with:

a single graphic object using:
ROP3 0xCA with original source fill pattern,
a rectangle fill path shape,
the generated 1-bit depth bitmap mask.

OR

a single graphic object using:
Original ROP of the detected glyph graphic object
a fill path which describes the trace ‘1’ bit of the generated 1-bit depth bitmap mask.

Also disclosed is a method of improving rendering performance by modifying the input drawing commands, the method comprising:

detecting a first glyph drawing command;

detecting a predetermined number of glyph drawing commands overlapping the first glyph drawing command;

allocating 1-bit depth bitmap buffer which has the same size as a bounding box of the first glyph expanded by a predetermined criterion;

combining at least the predetermined number of overlapping glyph drawing commands into allocated 1-bit depth bitmap; and

outputting a result of the combining step as a new drawing command.

Also disclosed is a method of simplifying a stream of graphic objects, the method comprising:

(i) receiving two or more graphic objects satisfying a per-object criterion;

(ii) storing the graphic objects in a display list satisfying a coalesced-object criterion;

(iii) generating a combined path outline and a minimal bit-depth operand of the display list; and

(iv) replacing the graphic objects satisfying the per-object criteria with the generated combined path outline and minimal bit-depth operand in the stream of graphic objects.

Also disclosed is a method of simplifying a stream of graphic objects, the method comprising:

(i) receiving two or more graphic objects satisfying per-object criteria;

(ii) storing the graphic objects in a display list satisfying a combined-object criterion, wherein at least one graphic object stored in the display list has an associated bit-mask;

(iii) generating a combined path outline and a minimal bit-depth operand of the display list, wherein the combined path-outline describes a union of the paint-path, clip and associated bit-mask, for each graphic object in the display list; and

(iv) replacing the graphic objects satisfying the per-object criterion with the generated combined path outline and minimal bit-depth operand in the stream of graphic objects.

Also disclosed is a method for rendering a plurality of graphical objects of an image on a scanline basis, each scanline comprising at least one run of pixels, each run of pixels being associated with at least one of the graphical objects such that the pixels of the run are within the edges of the at least one graphical object, said method comprising:

(i) decomposing each of the graphical objects into at least one edge representing the corresponding graphical objects;

(ii) sorting one or more arrays containing the edges representing the graphical objects of the image, at least one of the arrays being sorted in an order from a highest priority graphical object to a lowest priority graphical object;

(iii) determining at least one edge of the graphical objects defining a run of pixels of a scanline, at least one graphical objects contributing to the run and at least one edge of the contributing graphical objects, using the arrays; and

(iv) generating the run of pixels by outputting, if the highest priority contributing graphical object is opaque,
(a) a set of pixel data within the edges of the highest priority contributing graphical object to an image buffer; and
(b) a set of pixel-run tuples {x, y, num_pixels} to a pixel-run buffer;

otherwise,
(c) compositing a set of pixel data to an image buffer, and bit-wise OR-ing a set of bit-mask data onto a bit-run buffer, the set of pixel data and the set of bit-mask data associated with the highest priority contributing graphical object and one or more of further contributing graphical objects, and (d) emitting the composited bit-run buffer as a set of pixel-run tuples {x, y, num_pixels} to a pixel-run buffer for each sequence of 1-bits in the bit-run buffer, relative to the run-of-pixels.

Also disclosed is a system for modifying drawing commands to be input to a rendering process, the system comprising:

a memory for storing data and a computer program;

a processor coupled to said memory for executing said computer program, said computer program comprising instructions for:
detecting a first glyph drawing command;
detecting a predetermined number of further glyph drawing commands proximate within a threshold of the first glyph drawing command;
accumulating the predetermined number of proximate glyph drawing commands;
combining the accumulated proximate glyph drawing commands into a 1-bit depth bitmap; and
outputting the 1-bit depth bitmap to the rendering process as a new drawing command.

Also disclosed is a system for modifying drawing commands to be input to a rendering process, the system comprising:

a memory for storing data and a computer program;

a processor coupled to said memory for executing said computer program, said computer program comprising instructions for:
detecting a first drawing command for a first glyph;
detecting a predetermined number of drawing commands for further glyphs proximate the first glyph;
allocating 1-bit depth bitmap buffer which has the same size as a bounding box of the first glyph expanded by a predetermined criterion such that the expanded bounding box includes the first glyph and the proximate further glyphs;
combining the first drawing command and the at least said predetermined number of the proximate glyph drawing commands into the allocated 1-bit depth bitmap; and
outputting a new drawing command to the rendering process, the new drawing command comprises one of:
A. (Aa) the 1-bit depth bitmap;
   (Ab) a ROP3 0xCA operator; and
   (Ac) a fill-path shape, wherein said shape is filled with an original fill of the combined glyphs; and
B. (Ba) the original ROP of the first glyph;
   (Bb) a fill path which traces the “1” bits of the 1-bit depth bitmap; and
   (Bc) an original fill of the combined glyphs.

Also disclosed is a system for merging glyphs in a graphic object stream to be input to a rendering process, the system comprising:

a memory for storing data and a computer program;

a processor coupled to said memory for executing said computer program, said computer program comprising instructions for:
detecting, in the graphic object stream, a sequence of at least a predetermined number (N) of spatially proximate glyph graphic objects; and
merging the detected spatially proximate glyph graphic objects from the predetermined Nth spatially proximate glyph graphic object to a last spatially proximate glyph graphic object of the sequence into a 1-bit depth bitmap mask, the merging replacing the detected spatially proximate glyph graphic objects from the predetermined Nth spatially proximate glyph graphic object to the last detected spatially proximate glyph graphic object with:
a single graphic object determined using:
   ROP3 0xCA with original source fill pattern,
   a rectangle fill path shape, and
   the generated 1-bit depth bitmap mask;

or
a single graphic object determined using:
   original ROP of the detected glyph graphic object; and
   a fill path which describes a trace ‘1’ bit of the generated 1-bit depth bitmap mask.

Also disclosed is a system for processing a stream of drawing commands to be input to a rendering process, said system comprising:

a memory for storing data and a computer program;

a processor coupled to said memory for executing said computer program, said computer program comprising instructions for:
performing trend analysis on the stream to identify a plurality of consecutive glyph drawing commands having a determinable spatial proximity;
in response to the identification, combining the spatially proximate drawing commands to form a new drawing command; and

incorporating the new drawing command into the stream to the rendering process.

Also disclosed is an apparatus for modifying drawing commands to be input to a rendering process, the apparatus comprising:

means for detecting a first glyph drawing command;

means for detecting a predetermined number of further glyph drawing commands proximate within a threshold of the first glyph drawing command;

means for accumulating the predetermined number of proximate glyph drawing commands;

means for combining the accumulated proximate glyph drawing commands into a 1-bit depth bitmap; and

means for outputting the 1-bit depth bitmap to the rendering process as a new drawing command.

Also disclosed is an apparatus for modifying drawing commands to be input to a rendering process, the apparatus comprising:

means for detecting a first drawing command for a first glyph;

means for detecting a predetermined number of drawing commands for further glyphs proximate the first glyph;

means for allocating 1-bit depth bitmap buffer which has the same size as a bounding box of the first glyph expanded by a predetermined criterion such that the expanded bounding box includes the first glyph and the proximate further glyphs;

means for combining the first drawing command and the at least said predetermined number of the proximate glyph drawing commands into the allocated 1-bit depth bitmap; and

means for outputting a new drawing command to the rendering process, the new drawing command comprises one of:

A. (Aa) the 1-bit depth bitmap;
(Ab) a ROP3 0xCA operator; and
(Ac) a fill-path shape, wherein said shape is filled with an original fill of the combined glyphs; and

B. (Ba) the original ROP of the first glyph;
(Bb) a fill path which traces the “1” bits of the 1-bit depth bitmap; and
(Bc) an original fill of the combined glyphs.

Also disclosed is an apparatus for merging glyphs in a graphic object stream to be input to a rendering process, the apparatus comprising:

means for detecting, in the graphic object stream, a sequence of at least a predetermined number (N) of spatially proximate glyph graphic objects; and

means for merging the detected spatially proximate glyph graphic objects from the predetermined Nth spatially proximate glyph graphic object to a last spatially proximate glyph graphic object of the sequence into a 1-bit depth bitmap mask, the merging replacing the detected spatially proximate glyph graphic objects from the predetermined Nth spatially proximate glyph graphic object to the last detected spatially proximate glyph graphic object with:

a single graphic object determined using:
ROP3 0xCA with original source fill pattern,
a rectangle fill path shape, and
the generated 1-bit depth bitmap mask; or

a single graphic object determined using:
original ROP of the detected glyph graphic object; and
a fill path which describes a trace ‘1’ bit of the generated 1-bit depth bitmap mask.

Also disclosed is an apparatus for processing a stream of drawing commands to be input to a rendering process, said apparatus comprising:

means for performing trend analysis on the stream to identify a plurality of consecutive glyph drawing commands having a determinable spatial proximity and in response to the identification, combining the spatially proximate drawing commands to form a new drawing command; and

means for incorporating the new drawing command into the stream to the rendering process.

Also disclosed is a computer readable storage medium having a computer program recorded therein, the program being executable by a computer apparatus to make the computer perform a method of modifying drawing commands to be input to a rendering process, said program comprising:

code for detecting a first glyph drawing command;

code for detecting a predetermined number of further glyph drawing commands proximate within a threshold of the first glyph drawing command;

code for accumulating the predetermined number of proximate glyph drawing commands;

code for combining the accumulated proximate glyph drawing commands into a 1-bit depth bitmap; and

code for outputting the 1-bit depth bitmap to the rendering process as a new drawing command.

Also disclosed is a computer readable storage medium having a computer program recorded therein, the program being executable by a computer apparatus to make the computer perform a method of modifying drawing commands to be input to a rendering process, said program comprising:

code for detecting a first drawing command for a first glyph;

code for detecting a predetermined number of drawing commands for further glyphs proximate the first glyph;

code for allocating 1-bit depth bitmap buffer which has the same size as a bounding box of the first glyph expanded by a predetermined criterion such that the expanded bounding box includes the first glyph and the proximate further glyphs;

code for combining the first drawing command and the at least said predetermined number of the proximate glyph drawing commands into the allocated 1-bit depth bitmap; and

code for outputting a new drawing command to the rendering process, the new drawing command comprises one of:

A. (Aa) the 1-bit depth bitmap;
(Ab) a ROP3 0xCA operator; and
(Ac) a fill-path shape, wherein said shape is filled with an original fill of the combined glyphs; and

B. (Ba) the original ROP of the first glyph;
(Bb) a fill path which traces the “1” bits of the 1-bit depth bitmap; and
(Bc) an original fill of the combined glyphs.

Also disclosed is a computer readable storage medium having a computer program recorded therein, the program being executable by a computer apparatus to make the computer perform a method of merging glyphs in a graphic object stream to be input to a rendering process, said program comprising:

code for detecting, in the graphic object stream, a sequence of at least a predetermined number (N) of spatially proximate glyph graphic objects; and

code for merging the detected spatially proximate glyph graphic objects from the predetermined Nth spatially proximate glyph graphic object to a last spatially proximate glyph graphic object of the sequence into a 1-bit depth bitmap mask, the merging replacing the detected spatially proximate glyph graphic objects from the predetermined Nth spatially proximate glyph graphic object to the last detected spatially proximate glyph graphic object with:

a single graphic object determined using:
ROP3 0xCA with original source fill pattern,
a rectangle fill path shape, and
the generated 1-bit depth bitmap mask; or

a single graphic object determined using:
original ROP of the detected glyph graphic object; and
a fill path which describes a trace ‘1’ bit of the generated 1-bit depth bitmap mask.

Also disclosed is a computer readable storage medium having a computer program recorded therein, the program being executable by a computer apparatus to make the computer perform a method of processing a stream of drawing commands to be input to a rendering process, said program comprising:

code for performing trend analysis on the stream to identify a plurality of consecutive glyph drawing commands having a determinable spatial proximity and in response to the identification, combining the spatially proximate drawing commands to form a new drawing command; and

code for incorporating the new drawing command into the stream to the rendering process.

Other aspects are disclosed.

### BRIEF DESCRIPTION OF THE DRAWINGS

At least one embodiment of the invention will now be described with reference to the following drawings, in which:

FIGS. 1A and 1B form a schematic block diagram of a general purpose computer system upon which arrangements described can be practiced;

FIG. 2 is a schematic block diagram of a printer driver;

FIG. 3 illustrates a sequence of application-specified drawing instructions;

FIG. 4 illustrates an idiom recognition pipeline;

FIG. 5 illustrates a group-elevated idiom recognition pipeline;

FIG. 6 is a flowchart of an algorithm followed by a printer driver for processing graphical objects;

FIG. 7 is a flowchart of an algorithm followed by a printer driver for processing a group start drawing instruction;

FIG. 8 is a flowchart of an algorithm followed by a printer driver for processing a group end drawing instruction;

FIG. 9 is a flowchart of an algorithm followed by a printer driver for processing a paint object drawing instructions;

FIG. 10 is a continuation of the sequence of application-specified drawing instructions started in FIG. 3;

FIG. 11 is a schematic flow diagram for describing operation of a typical raster image processing system;

FIG. 12 is a schematic flow diagram of a method for detecting and combining overlapping glyph graphic objects;

FIG. 13 is a schematic flow diagram of a method for combining overlapping glyph graphic objects;

FIG. 14 is a diagram shows example of simple characters A, B, C & their bounding box;

FIG. 15 is a diagram shows example of combining three glyphs A, B, & C with the predetermined MinGlyphs value of 1, an a predetermined bounding box threshold;

FIG. 16A is a representation of an input suitable for the combining of different graphic object types;

FIG. 16B is a flowchart of a process for combining the objects in FIG. 16A;

FIGS. 16C to 16F are representations of outputs generated by different types of the combining;

FIG. 17 is a diagram of the modules of the printing system;

FIG. 18 is a diagram of the modules of the filter module as used in the system of FIG. 17;

FIG. 19 is a flow diagram illustrating a method of adding a sequence of graphic objects to a display list;

FIG. 20 is a flow diagram illustrating a method of flushing a stored sequence of one or more graphic objects to the Print Rendering System;

FIG. 21 is a flow diagram illustrating a method of constructing a mapping function to generate a minimal bit depth operand;

FIG. 22a is an exemplary diagram of a page containing a graphic object;

FIG. 22b is a diagram showing the components of the graphic object in FIG. 22a;

FIG. 22c is a diagram showing a path and an image which is a visually equivalent representation of the graphic object in FIG. 22a;

FIG. 23 is a flow diagram illustrating a method of compositing a group of objects between a pair of edges defining a span of pixels;

FIG. 24a is a diagram showing a pixel-run {300, 20, 10};

FIG. 24b is a diagram showing three active levels of the pixel-run in FIG. 24a;

FIG. 24c is a diagram showing the contents of the initialised bitrun buffer and image buffer referred to in FIG. 23;

FIG. 24d is a diagram showing the contents of the bitrun buffer and the image buffer after processing the first active level in FIG. 24b;

FIG. 24e is a diagram showing the contents of the bitrun buffer and the image buffer after processing the second active level in FIG. 24b;

FIG. 24f is a diagram showing the contents of the bitrun buffer and the image buffer after processing the third active level in FIG. 24b;

FIG. 25a is a diagram showing two active levels of the pixel-run in FIG. 24a;

FIG. 25b is a diagram showing the contents of the bitrun buffer and the image buffer after processing the first active level in FIG. 25a;

FIG. 25c is a diagram showing the contents of the bitrun buffer and the image buffer after processing the second active level in FIG. 25a;

FIG. 26a is a diagram of three graphic objects which form a trapezoid;

FIG. 26b is a diagram showing that the three graphic objects in FIG. 26a are drawn with both a source and pattern fill;

FIG. 26c is a diagram of a path and an image of the three graphic objects after processing by the filter module;

FIG. 26d is a diagram of the smallest region of the image of FIG. 26c which is sent to the print rendering system;

FIG. 27 is a table identifying a number of raster operations (ROPs);

FIG. 28 schematically illustrates how trend analysis can be used to delay invocation of the merging and combining of glyphs.

### DETAILED DESCRIPTION INCLUDING BEST MODE

### Computing Environment

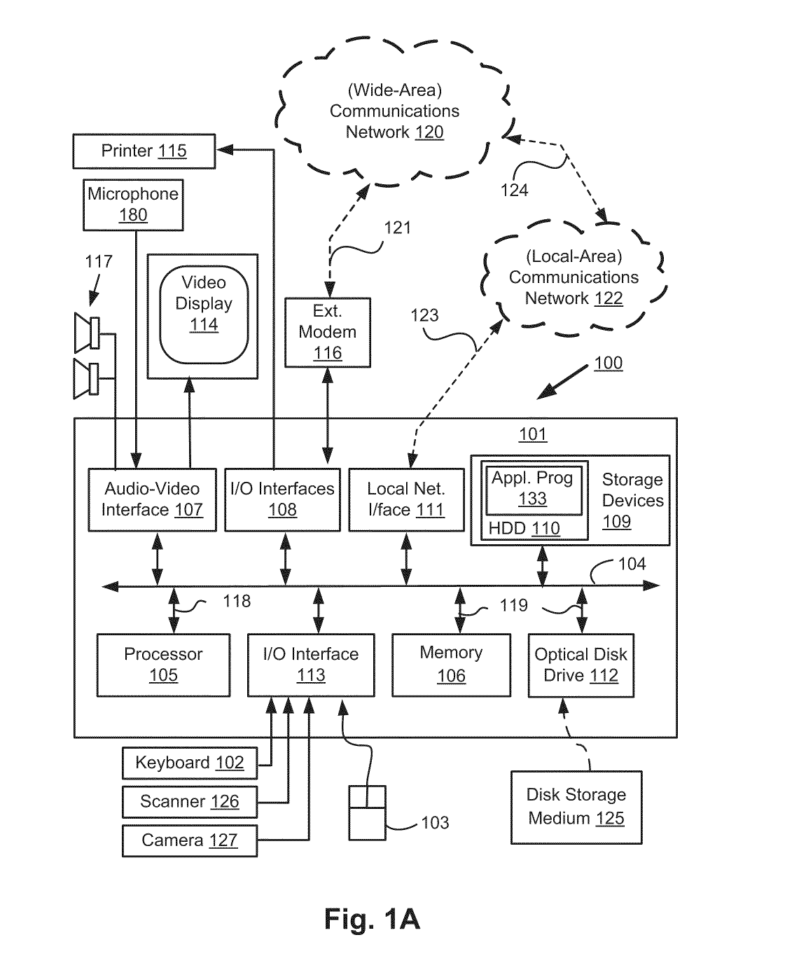

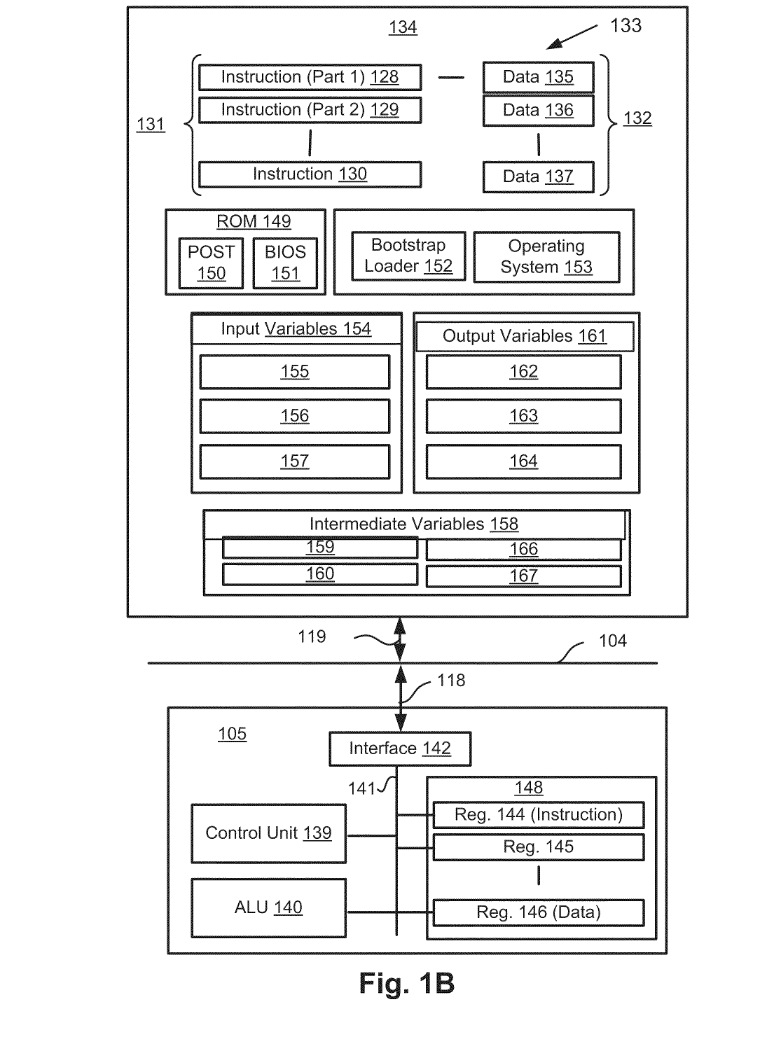

FIGS. 1A and 1B depict a general-purpose computer system 100, upon which the various arrangements described can be practiced.

As seen in FIG. 1A, the computer system 100 includes: a computer module 101; input devices such as a keyboard 102, a mouse pointer device 103, a scanner 126, a camera 127, and a microphone 180; and output devices including a printer 115, a display device 114 and loudspeakers 117. An external Modulator-Demodulator (Modem) transceiver device 116 may be used by the computer module 101 for communicating to and from a communications network 120 via a connection 121. The communications network 120 may be a wide-area network (WAN), such as the Internet, a cellular telecommunications network, or a private WAN. Where the connection 121 is a telephone line, the modem 116 may be a traditional “dial-up” modem. Alternatively, where the connection 121 is a high capacity (e.g., cable) connection, the modem 116 may be a broadband modem. A wireless modem may also be used for wireless connection to the communications network 120.

The computer module 101 typically includes at least one processor unit 105, and a memory unit 106. For example, the memory unit 106 may have semiconductor random access memory (RAM) and semiconductor read only memory (ROM). The computer module 101 also includes an number of input/output (I/O) interfaces including: an audio-video interface 107 that couples to the video display 114, loudspeakers 117 and microphone 180; an I/O interface 113 that couples to the keyboard 102, mouse 103, scanner 126, camera 127 and optionally a joystick or other human interface device (not illustrated); and an interface 108 for the external modem 116 and printer 115. In some implementations, the modem 116 may be incorporated within the computer module 101, for example within the interface 108. The computer module 101 also has a local network interface 111, which permits coupling of the computer system 100 via a connection 123 to a local-area communications network 122, known as a Local Area Network (LAN). As illustrated in FIG. 1A, the local communications network 122 may also couple to the wide network 120 via a connection 124, which would typically include a so-called “firewall” device or device of similar functionality. The local network interface 111 may comprise an Ethernet™ circuit card, a Bluetooth™ wireless arrangement or an IEEE 802.11 wireless arrangement; however, numerous other types of interfaces may be practiced for the interface 111.

The I/O interfaces 108 and 113 may afford either or both of serial and parallel connectivity, the former typically being implemented according to the Universal Serial Bus (USB) standards and having corresponding USB connectors (not illustrated). Storage devices 109 are provided and typically include a hard disk drive (HDD) 110. Other storage devices such as a floppy disk drive and a magnetic tape drive (not illustrated) may also be used. An optical disk drive 112 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 100.

The components 105 to 113 of the computer module 101 typically communicate via an interconnected bus 104 and in a manner that results in a conventional mode of operation of the computer system 100 known to those in the relevant art. For example, the processor 105 is coupled to the system bus 104 using a connection 118. Likewise, the memory 106 and optical disk drive 112 are coupled to the system bus 104 by connections 119. Examples of computers on which the described arrangements can be practised include IBM-PC's and compatibles, Sun Sparcstations, Apple Mac™ or a like computer systems.

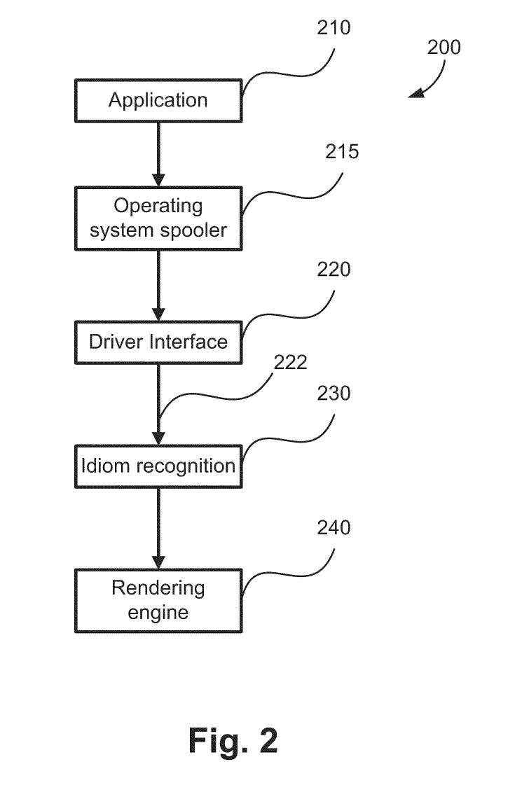

The methods of graphics processing to be described may be implemented using the computer system 100 wherein the processes of FIGS. 2 to 27, to be described, may be implemented as one or more software application programs 133 executable within the computer system 100. In particular, the methods of graphics processing are effected by instructions 131 (see FIG. 1B) in the software 133 that are carried out within the computer system 100. The software instructions 131 may be formed as one or more code modules, each for performing one or more particular tasks. The software may also be divided into two separate parts, in which a first part and the corresponding code modules performs the graphics processing methods and a second part and the corresponding code modules manage a user interface between the first part and the user.

The software may be stored in a computer readable medium, including the storage devices described below, for example. The software is loaded into the computer system 100 from the computer readable medium, and then executed by the computer system 100. A computer readable medium having such software or computer program recorded on the computer readable medium is a computer program product. The use of the computer program product in the computer system 100 preferably effects an advantageous apparatus for graphics processing.

The software 133 is typically stored in the HDD 110 or the memory 106. The software is loaded into the computer system 100 from a computer readable medium, and executed by the computer system 100. Thus, for example, the software 133 may be stored on an optically readable disk storage medium (e.g., CD-ROM) 125 that is read by the optical disk drive 112. A computer readable medium having such software or computer program recorded on it is a computer program product. The use of the computer program product in the computer system 100 preferably effects an apparatus for graphics processing.

In some instances, the application programs 133 may be supplied to the user encoded on one or more CD-ROMs 125 and read via the corresponding drive 112, or alternatively may be read by the user from the networks 120 or 122. Still further, the software can also be loaded into the computer system 100 from other computer readable media. Computer readable storage media refers to any storage medium that provides recorded instructions and/or data to the computer system 100 for execution and/or processing. Examples of such storage media include floppy disks, magnetic tape, CD-ROM, DVD, Blu-ray Disc, a hard disk drive, a ROM or integrated circuit, USB memory, a magneto-optical disk, or a computer readable card such as a PCMCIA card and the like, whether or not such devices are internal or external of the computer module 101. Examples of computer readable transmission media that may also participate in the provision of software, application programs, instructions and/or data to the computer module 101 include radio or infra-red transmission channels as well as a network connection to another computer or networked device, and the Internet or Intranets including e-mail transmissions and information recorded on Websites and the like.

The second part of the application programs 133 and the corresponding code modules mentioned above may be executed to implement one or more graphical user interfaces (GUIs) to be rendered or otherwise represented upon the display 114. Through manipulation of typically the keyboard 102 and the mouse 103, a user of the computer system 100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 117 and user voice commands input via the microphone 180.

FIG. 1B is a detailed schematic block diagram of the processor 105 and a “memory” 134. The memory 134 represents a logical aggregation of all the memory modules (including the HDD 109 and semiconductor memory 106) that can be accessed by the computer module 101 in FIG. 1A.

When the computer module 101 is initially powered up, a power-on self-test (POST) program 150 executes. The POST program 150 is typically stored in a ROM 149 of the semiconductor memory 106 of FIG. 1A. A hardware device such as the ROM 149 storing software is sometimes referred to as firmware. The POST program 150 examines hardware within the computer module 101 to ensure proper functioning and typically checks the processor 105, the memory 134 (109, 106), and a basic input-output systems software (BIOS) module 151, also typically stored in the ROM 149, for correct operation. Once the POST program 150 has run successfully, the BIOS 151 activates the hard disk drive 110 of FIG. 1A. Activation of the hard disk drive 110 causes a bootstrap loader program 152 that is resident on the hard disk drive 110 to execute via the processor 105. This loads an operating system 153 into the RAM memory 106, upon which the operating system 153 commences operation. The operating system 153 is a system level application, executable by the processor 105, to fulfil various high level functions, including processor management, memory management, device management, storage management, software application interface, and generic user interface.

The operating system 153 manages the memory 134 (109, 106) to ensure that each process or application running on the computer module 101 has sufficient memory in which to execute without colliding with memory allocated to another process. Furthermore, the different types of memory available in the system 100 of FIG. 1A must be used properly so that each process can run effectively. Accordingly, the aggregated memory 134 is not intended to illustrate how particular segments of memory are allocated (unless otherwise stated), but rather to provide a general view of the memory accessible by the computer system 100 and how such is used.

As shown in FIG. 1B, the processor 105 includes a number of functional modules including a control unit 139, an arithmetic logic unit (ALU) 140, and a local or internal memory 148, sometimes called a cache memory. The cache memory 148 typically include a number of storage registers 144-146 in a register section. One or more internal busses 141 functionally interconnect these functional modules. The processor 105 typically also has one or more interfaces 142 for communicating with external devices via the system bus 104, using a connection 118. The memory 134 is coupled to the bus 104 using a connection 119.

The application program 133 includes a sequence of instructions 131 that may include conditional branch and loop instructions. The program 133 may also include data 132 which is used in execution of the program 133. The instructions 131 and the data 132 are stored in memory locations 128, 129, 130 and 135, 136, 137, respectively. Depending upon the relative size of the instructions 131 and the memory locations 128-130, a particular instruction may be stored in a single memory location as depicted by the instruction shown in the memory location 130. Alternately, an instruction may be segmented into a number of parts each of which is stored in a separate memory location, as depicted by the instruction segments shown in the memory locations 128 and 129.

In general, the processor 105 is given a set of instructions which are executed therein. The processor 1105 waits for a subsequent input, to which the processor 105 reacts to by executing another set of instructions. Each input may be provided from one or more of a number of sources, including data generated by one or more of the input devices 102, 103, data received from an external source across one of the networks 120, 102, data retrieved from one of the storage devices 106, 109 or data retrieved from a storage medium 125 inserted into the corresponding reader 112, all depicted in FIG. 1A. The execution of a set of the instructions may in some cases result in output of data. Execution may also involve storing data or variables to the memory 134.

The disclosed graphics processing arrangements use input variables 154, which are stored in the memory 134 in corresponding memory locations 155, 156, 157. The graphics processing arrangements produce output variables 161, which are stored in the memory 134 in corresponding memory locations 162, 163, 164. Intermediate variables 158 may be stored in memory locations 159, 160, 166 and 167.

Referring to the processor 105 of FIG. 1B, the registers 144, 145, 146, the arithmetic logic unit (ALU) 140, and the control unit 139 work together to perform sequences of micro-operations needed to perform “fetch, decode, and execute” cycles for every instruction in the instruction set making up the program 133. Each fetch, decode, and execute cycle comprises:

(a) a fetch operation, which fetches or reads an instruction 131 from a memory location 128, 129, 130;

(b) a decode operation in which the control unit 139 determines which instruction has been fetched; and

(c) an execute operation in which the control unit 139 and/or the ALU 140 execute the instruction.

Thereafter, a further fetch, decode, and execute cycle for the next instruction may be executed. Similarly, a store cycle may be performed by which the control unit 139 stores or writes a value to a memory location 132.

Each step or sub-process in the graphics processing of FIGS. 2 to 27 is associated with one or more segments of the program 133 and is performed by the register section 144, 145, 147, the ALU 140, and the control unit 139 in the processor 105 working together to perform the fetch, decode, and execute cycles for every instruction in the instruction set for the noted segments of the program 133.

### Dynamic Pipeline

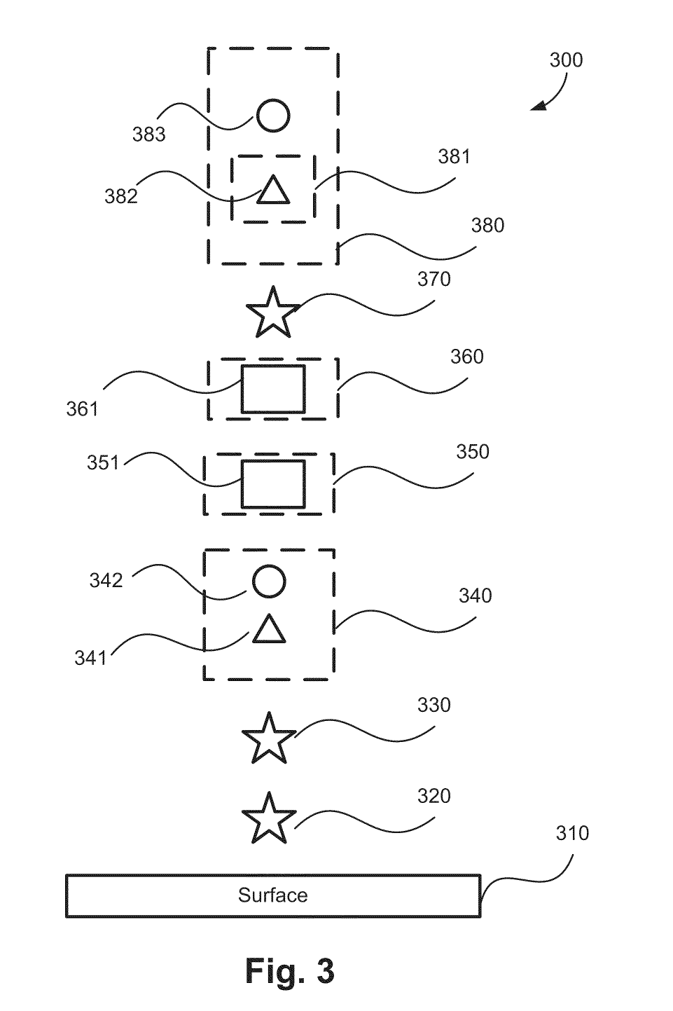

FIG. 2 shows a function data flow of a printer driver process 200 operable within the computer system 100. An application 210, which may form part of the application 133, issues drawing instructions to an operating system spooler module 215, typically using an industry standard interface such as GDI. Operating system spooler module 215 will typically convert these drawing instructions to a standardized spool file format such as PDF or XPS, and pass the standardized file format to a driver interface module 220. The driver interface module 220 then interprets the spooled file format, and issues printer-driver drawing instructions 222 to an idiom recognition module 230. Desirably, the printer-driver set of instructions 222 implemented by driver interface module 220 includes “group start”, “group end” and “paint object” drawing instructions. These instructions will be explained later with reference to FIG. 3. Idiom recognition module 230 receives drawing instructions 222 from driver interface module 220, and simplifies these instructions for the purpose of reducing the processing time required by a rendering engine 240. Rendering engine 240 accepts simplified drawing instructions from idiom recognition module 230, performs rendering processing, and outputs pixels, which may, for example, be displayed to the display screen 114, or output to the printing device 115. The rendering engine 240 may be implemented in hardware for special purpose applications, or implemented in software for more general purpose applications. Hardware implementations may be accommodated within the computer module 1010 or within the printer 115, for example.

FIG. 3 illustrates an example of a sequence 300 of drawing commands issued by driver interface module 220, and processed by idiom recognition module 230. Surface 310 typically represents a chunk of memory, for example within the memory 106, used store the pixels for the page rendered by rendering engine 240, and is typically initialized by rendering engine 240 to contain all-white pixels. Driver interface module 220 issues drawing instructions 320 to 383 to idiom recognition module 230 in order from the bottom-most instruction 320, to the top-most instruction 383. A first star shape 320 is a “paint object” drawing instruction, which may be immediately rendered by rendering engine 240 onto surface 310. The second star shaped drawing instruction 330 may then be rendered by rendering engine 240 onto surface 310. The bottom of dashed box 340 represents a “group start” instruction, and the top of dashed box 340 represents a “group end” instruction. Objects 341 (triangle) and 342 (circle) are contained within the group 340. The objects may be of different types, for example, selected from vector graphics or bitmaps. The rendering engine 240 cannot place object 341 directly onto drawing surface 310. For groups, such as group 340, the rendering engine 240 must first render the objects contained within the group (being in this case the triangular shape 341 and circular shape 342) onto an intermediate fully-transparent surface. Rendering engine 240 can then draw the intermediate, and now semi-transparent, surface onto the surface 310. The dashed box 380 enclosing objects 381 to 383 illustrates an example of a nested group. In order to render the group 380, rendering engine 240 must create a first intermediate fully-transparent surface and a second intermediate fully-transparent surface. The rendering engine 240 then renders shape 382 (triangle) onto the second intermediate surface. Rendering engine 240 then draws the now semi-transparent second intermediate surface onto the first intermediate surface. Rendering engine 240 then draws shape 383 (circle) onto first intermediate surface. Rendering engine 240 then draws the now semi-transparent first intermediate surface onto surface 310.

There are numerous examples in which driver interface module 220 would choose to embed paint object drawing instructions within printer-driver start group and end group drawing instructions. One such example occurs when the spooled file generated by operating system spooler 215 is in the PDF, and the PDF file contains a PDF transparency group, which may then be represented by a printer driver group. Another example occurs when the spooled file generated by operating system spooler 215 is XPS, and the XPS file contains an object which is filled by objects specified within a tiled visual brush. The tiled visual brush and its contained objects may then be represented by a printer driver group with a tiling property.

A printer driver group typically offers a variety of options. For example, driver interface module 220 can specify parameters to create a group which will translate the position of objects contained within the group on drawing surface 310, tile the contained objects within a sub-area of surface 310, or composite the contained objects with drawing surface 310 using a raster operator (ROP).

As previously explained, the rendering engine 240 must create an intermediate surface for every group. Creating an intermediate surface, and combining the intermediate surface onto drawing surface 310 can be an expensive operation in terms of performance and memory consumption. Presently described is an algorithm or process, executed by idiom recognition module 230, intended to reduce the number of graphical objects and groups sent by idiom recognition module 230 to the rendering engine 240. The intent of the algorithm executed by idiom recognition module 230 is to combine multiple objects within a single group, and where possible, combine and eliminate adjacent groups containing a single object. With reference to FIG. 3, idiom recognition module 230 attempts to combine objects 341 and 342. Idiom recognition module 230 also attempts to combine objects 351 and 361, and thereby eliminate groups 350 and 360, thus optimising graphics processing.

The rules for when the idiom recognition module 230 can combine objects, and when the idiom recognition module 230 can eliminate groups are complex. For example, two objects which are within close proximity to each other on the drawing surface 310, are opaque, and have the same colour, can easily be combined. On the other hand, objects which do not meet such criteria are more difficult to combine. The idiom recognition module 230 may therefore determine that there is no performance benefit to rendering engine 240 by performing difficult combination processing, and may therefore choose not to carry out the combination operation.

Similarly, the effort required by idiom recognition module 230 to eliminate a group is dependent on the properties of the group, and the properties of objects contained within the group. For example, a group which simply specifies a graphical translation operation can easily be eliminated, as the translation operation can be incorporated into the paint object instruction for the contained objects. As another example, a group may specify a ternary raster operation (ROP3) to be applied when combining the group's contents with the background. In the case where the group consists entirely of objects drawn with a COPYPEN operation, the group may be eliminated, and each contained object may be drawn using a paint object instruction which incorporates the ROP3 operation rather than the COPYPEN operation. On the other hand, if the contained objects themselves require a ROP3 operator, idiom recognition module 230 may deem the effort required to eliminate the containing group to be too complex. In following sections where combining of objects and group removal are referred to, it is to be understood that the application of these processes is subject to the discretion of idiom recognition module 230 based on the estimated complexity of these processes.

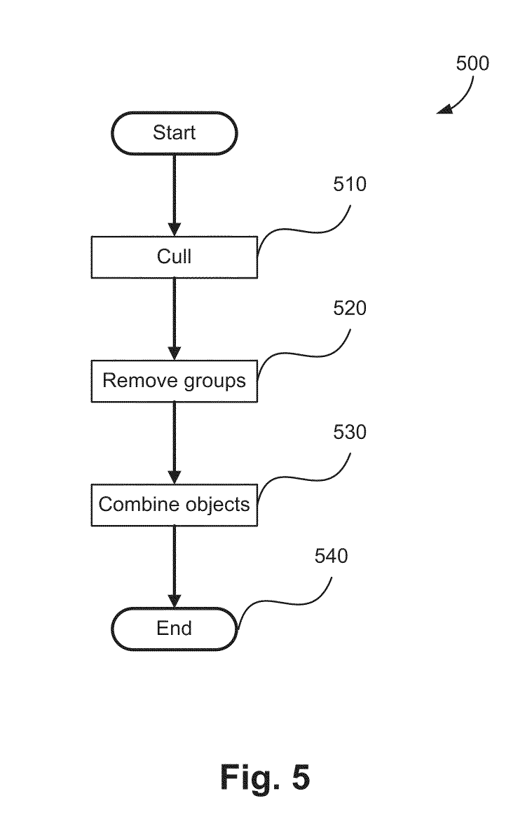

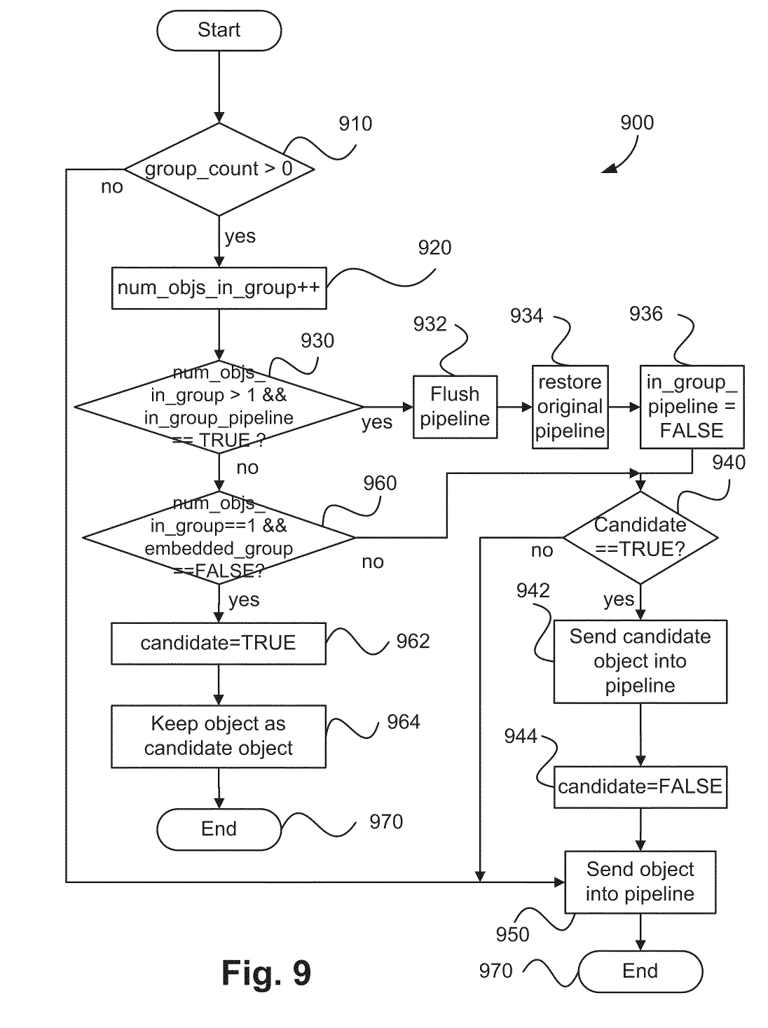

An exemplary algorithm or process executed by idiom recognition module 230 is described with reference to FIGS. 3 to 9. The exemplary embodiment illustrates by example with reference to FIG. 3, an algorithm that uses a group raised pipeline 500 of FIG. 5 whenever a criteria of having two groups (350, 360), each group having one object (351, 361), is satisfied. In alternate embodiments, broader criteria are possible with relevant adjustment to the described algorithm. For example, it is possible to use the pipeline 500 if a group contains more than 1 object, provided group removal criteria checking is carried out on multiple candidate objects at steps 962, 964 seen in FIG. 9.

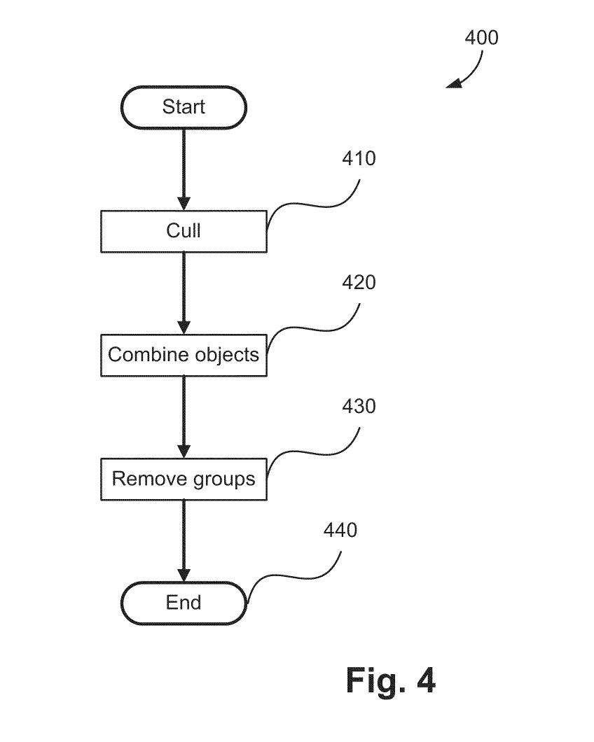

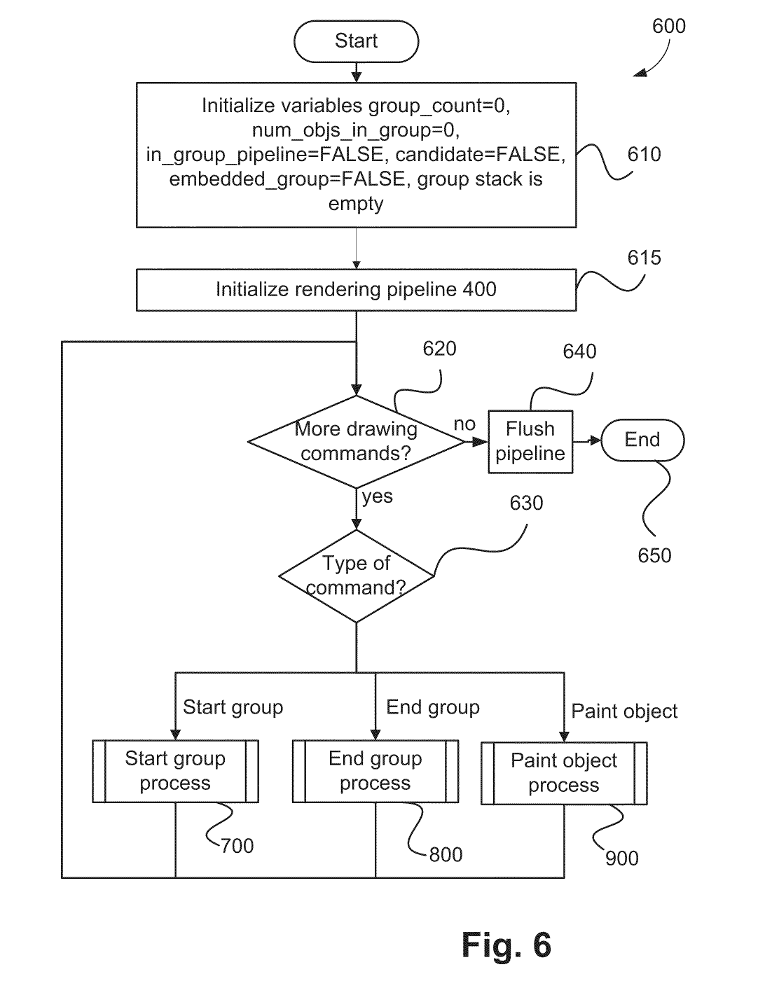

FIG. 6 shows an algorithm or process 600 executed by idiom recognition module 230. As such, the algorithm 600 may be implemented in software as part of the application 133 and executable by the processor 105 as part of graphics processing optimisation. At step 610, variables are initialised in memory module 106. In particular, group_count is set to 0, num_objs_in_group is set to 0, in_group_pipeline is set to FALSE, candidate is set to TRUE, embedded_group is set to FALSE and group stack is initialised to being empty. At step 615, rendering pipeline 400, seen in FIG. 4, is initialized. The rendering pipeline 400 consists of several units. Culling unit 410 removes objects which are not visible on surface 310, such as objects which are completely off the surface, are completely obscured, or are completely clipped out through clipping operations. Combine objects unit 420 combines multiple compatible graphical objects into a single object. Remove groups unit 430 is responsible for the removal of groups, where possible. The pipeline ends at step 440, at which point idiom recognition module 230 issues drawing commands to rendering engine 240.

The present process of rendering is explained using the drawing instructions in FIG. 3. At a buffering step 620, idiom recognition module 230 waits for more drawing instructions from driver interface module 220. In this example, driver interface module 220 draws object 320. At command type determining step 630 it is determined that the object 320 is a paint object command, and paint object process 900 is executed (see FIG. 9). Referring to FIG. 9, at an initial group count determining step 910 the group count is 0, and processing proceeds to an object sending step 950, where the object 320 is sent into rendering pipeline 400. The culling unit 410 determines that the object is visible, and passes object 320 to object combining unit 420. This unit 420 determines that the object may be combined, and caches the object. Control then returns to process 900, which ends at the terminating step 970 because there is no further objects in the group. This process is returns to buffering step 620 of FIG. 6 until all objects on a page is processed.

Next, the driver interface module 220 draws the second star-shaped object 330. Idiom recognition module 230 executes command type determining step 630, and in this instance determines that object 330 is another paint object command, and executes process 900 for processing a paint object drawing instruction. At the group count determining step 910 the group count is 0, so control continues to the object sending step 950. At object sending step 950, object 330 is sent into rendering pipeline 400. The culling unit 410 again passes the star-shaped object 330 through to combine objects unit 420. Combine objects unit 420 determines that object 330 is compatible with its current cached object 320, and therefore combines the second star-shaped object 330 with its currently cached object, the first star-shaped object 320 to produce a new combined cached object 320,330. The process 900 terminates at the END step 970, and control returns to buffering step 620.

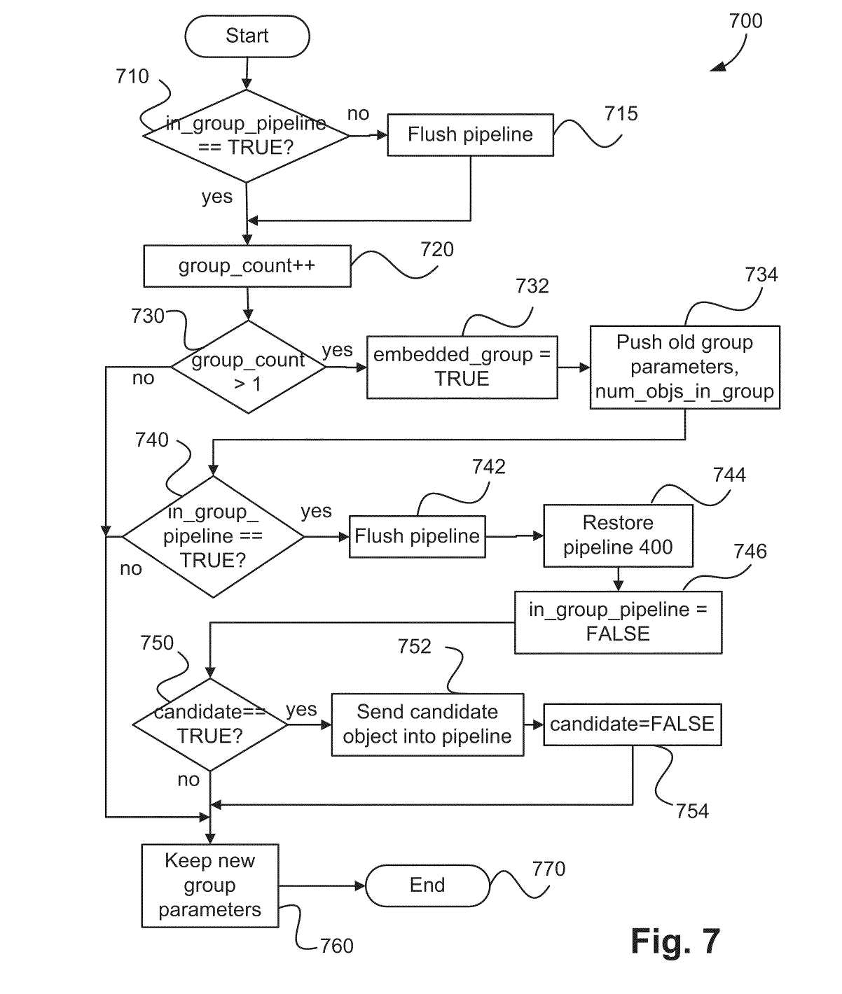

Driver interface module 220 then issues a group start command for object 340. Idiom recognition module 230 then determines at command type recognition step 630 that this is a group start command, and consequently executes a process 700 for processing a group start drawing instruction, as seen in FIG. 7. Referring to FIG. 7, at step 710, the objects in a group are determined. In this case, the variable “in_group_pipeline” is FALSE because both the star-shaped objects 320 and 330 are not in a group, so control continues to step 715, where the pipeline 400 is flushed. This flushing involves the combine object unit 420 sending its cached, combined object 320,330 to remove groups unit 430. The remove groups unit 430 passes combined object 320,300 on, pipeline processing terminates at step 440, and the combined object 320,330 is passed to rendering engine 240. At step 720 the group count is incremented. At step 730 the group count is 1, so control passes to “keep new group parameters” step 760, where the group parameters are kept, and the process 700 terminates at step 770, and returning control to step 620.

Driver interface module 220 then draws object 341. At command type determining step 630 the command is recognised as being a paint object command, and process 900 for processing a paint object drawing instruction is executed. At step 910 the group count is 1, and at step 920 num_objs_in_group is incremented to 1. At step 930 num_objs_in_group is 1, and at step 960 embedded group is FALSE, so at step 962 the variable candidate is set to TRUE, at step 964, the object 341 is kept as a candidate. The process 900 for processing a paint object drawing instruction terminates at step 970, and control returns to step 620.

Driver interface module 220 then draws object 342. At step 630, the drawing command is recognised to be a paint object command, and process 900 is again executed. At step 910 the group count is 1, at step 920 num_objs_in_group is incremented to 2. At step 930 in_group_pipeline is FALSE and at step 960 num_objs_in_group is 2. At step 940 candidate is TRUE. At step 942 candidate object 341 is sent into object pipeline 400. Object 341 is examined by the culling unit 410, and is cached by combine objects unit 420. At step 944 the variable candidate is set to FALSE, and at step 950 object 342 is sent into pipeline 400. Object 342 is also processed by culling unit 410 and combine objects unit 420. The unit 420 combines objects 341 and 342 and caches a combined object 341,342. Process 900 terminates at 970, and control returns to step 620.

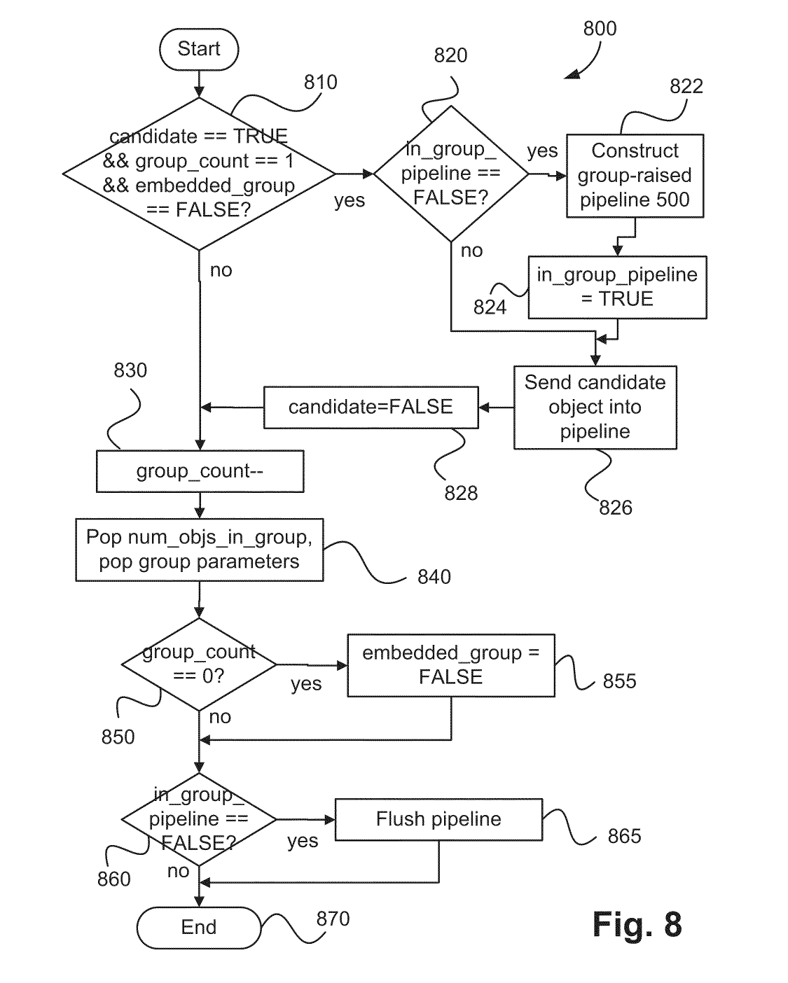

Driver interface module 220 then issues an end-group command for object 340. The command type is discerned at step 630, and a process 800 as seen in FIG. 8 for processing a group end drawing instruction is executed. Referring to FIG. 8, at step 810 candidate is FALSE, and therefore at step 830 the group count is decremented to 0. At step 840 the group stack is empty, so the pop operations do nothing. At step 850 the group count is 0, so embedded_group is set to FALSE at step 855. At step 860 in_group_pipeline is FALSE, so at step 865 the pipeline is flushed. Consequently, the combine objects unit 420 outputs the combined objects 341,342 to remove groups unit 430. If possible, the unit 430 removes group 340. The pipeline operations terminate at step 440, and the combined object 341,342 is passed to rendering engine 240. Idiom recognition module 230 has therefore fulfilled its intention to combine multiple objects within a group where possible. Process 800 terminates at 870, and control returns back to step 620.

Driver interface module 220 then issues a group-start command for object 350. At step 630 the command type is discerned, and process 700 for processing a group start drawing instruction is executed. At step 710 in_group_pipeline is FALSE, at step 715 pipeline 400 is flushed, at step 720 the group count is incremented to 1, at step 730 the group count is 1. At step 760 the group parameters are kept, process 700 terminates at 770, and control returns to step 620.

Driver interface module 220 then draws object 351. At step 630 it is determined that a paint object command was issued, and process 900 is executed. At step 910 the group count is 1, at step 920 num_objs_in_group is incremented to 1, and at step 930 num_objs_in_group is 1. At step 960 num_objs_in_group is 1 and embedded_group is FALSE. At step 962 candidate is set to TRUE, at step 964 object 351 is kept as a candidate, process 900 terminates at 970, and control returns to step 620.

Driver interface module 220 then issues a group-end command for object 350. The command is discerned at step 630, and process 800 is executed. At step 810 the condition is satisfied, and at step 820 in_group_pipeline is FALSE.

In the exemplary implementation, at step 822 the pipeline 500 is constructed and activated. In other implementations, an extended algorithm is implemented in which the construction of pipeline 500 is delayed until a predetermined threshold of occurrences of the sequence group start 350, paint object 351, group end 350 are observed in sequence of drawing commands. The extended algorithm results in an advantage in instances where an initial threshold of occurrences is commonly followed by a greater number of occurrences, and therefore, the cost of altering pipeline 400 is avoided in many cases where the benefit is negligible, and the cost is incurred in cases where the benefit is likely to be substantial. For example the extent of delay for the invocation of the construction of the pipeline can be varied according to the particular application. The present inventors have found, for example, that when observing and identifying text object s in the graphic object stream, a consecutive sequence in the range of about 15 to 25 such text objects is a suitable delay trigger to invoke the pipeline. The inventors have found that streams of less than 15 text objects do not incur a significant computational overhead, whilst computational savings can be achieved and are valuable where the stream has more than 15 or so text objects. The actual setting of the threshold may vary based upon complexity. For example, simple text objects in a simple font such as Arial the threshold may be 25, whereas for complex text objects in a complex font, such as Symbol Bold, the threshold may be 15.

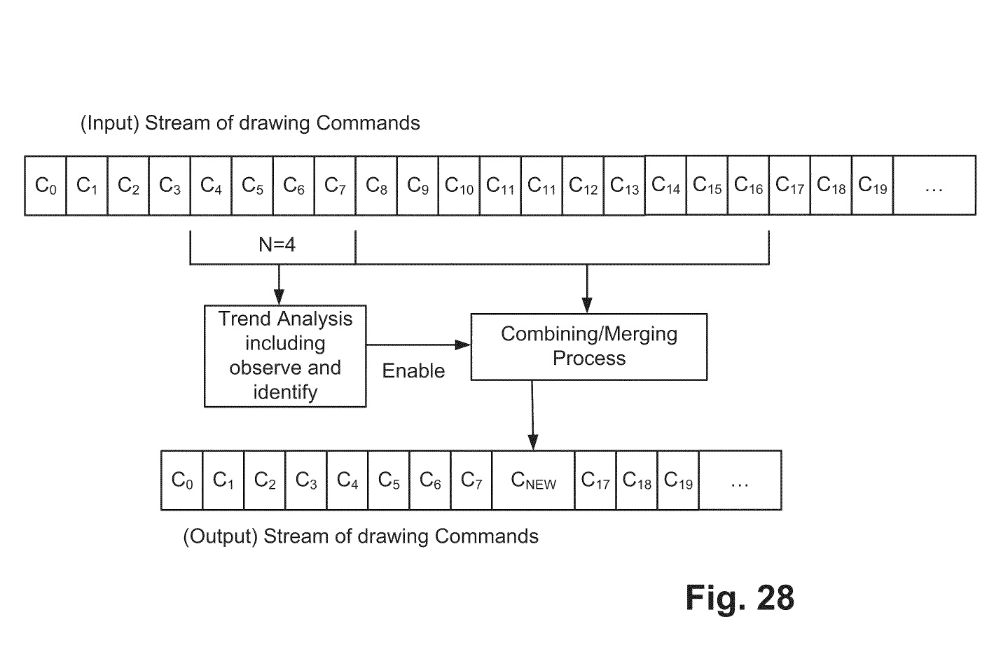

FIG. 28 illustrates this schematically where an input stream of drawing command C0 to C19 are shown. In this example, commands C₀ to C₃ relate to objects for which there is no overlap. However, trend analysis detects or identifies a number of objects for which there is overlap. Significantly, commands C₄ to C₇ are consecutive overlapping commands and this correspond to a predetermined threshold number N=4, used for illustrative purposes in this example. As a consequence the identification of commands C₄ to C₇ enables the combining of subsequent consecutive commands that overlap within desired criteria. In this case, those are commands C₈ to C₁₆. Those commands are then combined into a new command C_{NEW}, which is inserted into the output command stream between adjacent commands C₇ and C₁₇.

At step 824, the variable in_group_pipeline is set to TRUE. At step 826 candidate object 351 is sent into the pipeline 500. A culling unit 510 determines that object 351 is visible, and passes object 351 to remove groups unit 520. The unit 520 removes group 350 where possible, typically by embedding group 350 parameters into the properties of object 351. The remove groups unit 520 then passes object 351 to combine objects unit 530. This unit 530 then caches object 351. Control returns to step 828, where candidate is set to FALSE, and at step 830 the group count is decremented to 0. At step 840 the group stack is empty, so nothing is popped from the stack. At step 850 the group count is 0, so at step 855 embedded_group is set to FALSE. At step 860 in_group_pipeline is TRUE, process 800 terminates at 870, and control returns to step 620.

Driver interface module 220 then issues a start-group command for object 360. The command is discerned at step 630, and the process 700 is executed. At step 710, in_group_pipeline is TRUE, at step 720 group_count is incremented to 1. At step 730 group_count is 1, so at step 760 the new group parameters are kept, process 700 terminates at 770, and control continues to step 620.

Driver interface module 220 then issues a drawing command for object 361. At step 630 the command type is discerned to be paint object, and process 900 is executed. At step 910 the group count is 1, at step 920 num_objs_in_group is incremented to 1. At step 930 the num_objs_in_group is 1, at step 960 num_objs_in_group is 1 and embedded_group is FALSE. At step 962 candidate is set to TRUE, at step 964 object 361 is kept as a candidate, process 900 terminates at 970, and control returns to step 620.

Driver interface module 220 then issues an end-group command for object 360. The drawing command is discerned at step 630, and process 800 is executed. At step 810 the condition is satisfied, at step 820 in_group_pipeline is TRUE, and at step 826 object 361 is sent to pipeline 500. The culling unit 510 determines that object 361 is visible, the remove groups unit 520 then removes group 360 if possible, and the combine objects unit 530 combines objects 351,361 to produce a cached combined object 351,361. Idiom recognition module 230 has therefore achieved its intent to combine objects 351 and 361, and eliminating groups 350 and 360. Control returns to step 828 where candidate is set to FALSE, and at step 830 group_count is decremented to 0. At step 840 the group stack is empty, so nothing is popped from the stack. At step 850 the group count is 0, at step 855 embedded_group is set to FALSE. At step 860 in_group_pipeline is TRUE, process 800 terminates at 870, and control returns to step 620.

Driver interface module 220 then issues a drawing command for object 370. At step 630 the drawing command is discerned to be paint object, and process 900 is executed. At step 910, group_count is 0, at step 950, object 370 is sent into pipeline 500. The culling unit 510 passes object 370 on, the remove groups unit 520 determines that no group is active and passes object 370 on to combine objects unit 530. The unit 530 attempts to combine object 370 with its cached combined object 351,361. A successful combination results in a combined 351,361,370 object. An unsuccessful combination results in combined object 351,361 being passed to pipeline end 540, and further to rendering engine 240. The combine object unit 530 caches object 370. Process 900 terminates at 970, and control returns to step 620.

Driver interface module 220 then issues a group-start command for object 380. At step 630 the command type is discerned, and process 700 is executed. At step 710 in_group_pipeline is TRUE, at step 720 group_count is incremented to 1, at step 730 group_count is 1, so at step 760 group 380 parameters are kept, process 700 terminates at 770, and control returns to step 620.

Driver interface module 220 then issues a group-start command for object 381. At step 630 the drawing command is discerned, and process 700 is executed. At step 710 in_group_pipeline is TRUE. At step 720 the group count is incremented to 2. At step 730 group_count is 2, at step 732 embedded_group is set to TRUE. At step 734 group 380 parameters and num_objs_in_group (value 0) are pushed onto the group stack. At step 740 in_group_pipeline is TRUE, at step 742 pipeline 500 is flushed, resulting in unit 530 passing its combined object to pipeline end 540, and the combined object is passed to rendering engine 240. At step 744 pipeline 400 is restored and activated. At step 746 in_group_pipeline is set to FALSE, at step 750 candidate is FALSE, at step 760 group 381 parameters are kept, process 700 terminates at 770, and control returns to step 620.

Driver interface module 220 then issues a drawing command for object 382. The drawing command is discerned at step 630, and process 900 is executed. At step 910 the group count is 2, at step 920 num_objs_in_group is set to 1, at step 930 num_objs_in_group is 1, at step 960 num_objs_in_group is 1 and embedded group is TRUE. At step 940, candidate is FALSE. At step 950 object 382 is sent into pipeline 400. Unit 410 passes object 382 on, unit 420 caches object 382. Process 900 terminates at 970, and control returns to step 620.

Driver interface module 220 then issues a group-end command for object 381. The drawing command is discerned at step 630, and process 800 is executed. At step 810 candidate is FALSE, at step 830 group_count is decremented to 1, at step 840 group 380 parameters and num_objs_in_group (value 0) is popped out of the group stack. At step 850 group_count is 1, at step 860 in_group_pipeline is FALSE, and at step 865 pipeline 400 is flushed. This results in the combine object unit 420 passing object 382 on. The remove object unit 430, if possible, removes group 381, and passes object 382 to pipeline end 440, and object 381 is then sent to rendering engine 240. Process 800 terminates at 870, and control returns to step 620.

Driver interface module 220 then issues a drawing command for object 383. The drawing command is discerned at step 630, and process 900 is executed. At step 910 the group_count is 1, at step 920 num_objs_in_group is incremented to 1, at step 930 num_objs_in_group is 1. At step 960 the embedded_group is TRUE, at step 940 candidate is FALSE, and at step 950 object 383 is sent into pipeline 400. The culling unit 410 passes object 383 on, and the combine objects unit 420 then caches object 383. Process 900 terminates at 970, and control returns to step 620.

Driver interface module 220 then issues a group-end command for object 380. The drawing command is discerned at step 630, and process 800 is executed. At step 810, candidate is FALSE, at step 830 group count is decremented to 0, at step 840 the group stack is empty so nothing is popped. At step 850 group_count is 0, at step 855 embedded_group is set to FALSE, at step 860 in_group_pipeline is FALSE, and at step 865 pipeline 400 is flushed. Unit 420 passes object 383 on. Unit 430 attempts to remove group 380, and passes object 383 to pipeline end 440. Object 383 is then passed to rendering engine 240. Process 800 terminates at 870, and control returns to step 620.

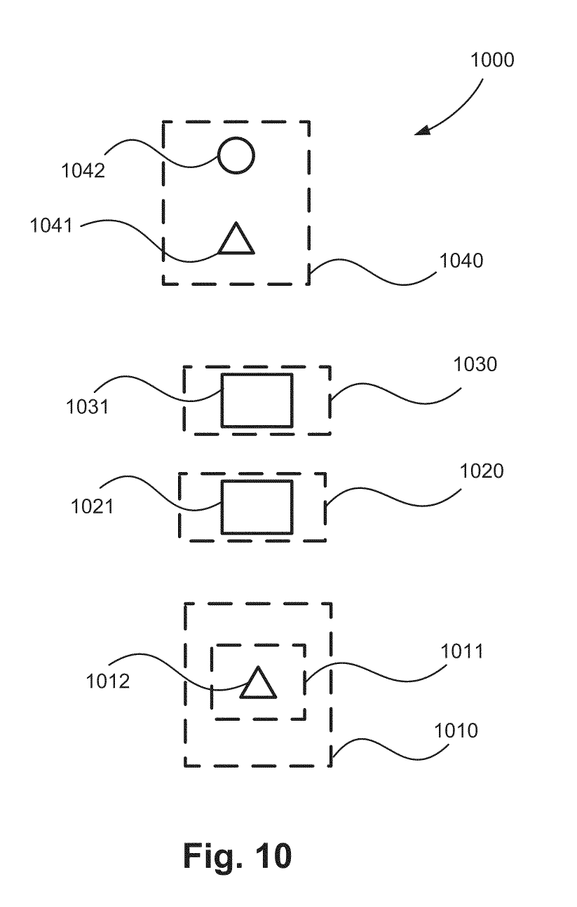

For the purpose of clarifying the method, the example drawing sequence illustrated in FIG. 3 can be drawn using the algorithm described in FIGS. 6 to 9, as shown in FIG. 10.

With reference to FIG. 10, the driver interface module 220 issues a group start drawing command for object 1010. The type of command is discerned at step 630, and process 700 is executed. At step 710 in_group_pipeline is FALSE, at step 715 pipeline 400 is flushed, at step 720 group_count is incremented to 1. At step 730 group_count is 1, at step 760 group 1010 parameters are kept, process 700 terminates at 770, and control returns to step 620.

Driver interface module 220 issues a group start drawing command for object 1011. The type of command is discerned at step 630, and process 700 is executed. At step 710 in_group_pipeline is FALSE, at step 715 pipeline 400 is flushed, at step 720 group_count is incremented to 2. At step 730 group_count is 2, at step 732 embedded_group is set to TRUE, at step 734 group 1010 parameters and num_objs_in_group (value 0) are pushed onto the stack. At step 740 in_group_pipeline is FALSE. At step 760 group 1011 parameters are kept, process 700 terminates at 770, and control returns to step 620.

Driver interface module 220 issues a paint object drawing command for object 1012. The type of command is discerned at step 630, and process 900 is executed. At step 910 group_count is 2, at step 920 num_objs_in_group is incremented to 1, at step 930 num_objs_in_group is 1, at step 960 embedded_group is TRUE. At step 940 candidate is FALSE. At step 950 object 1012 is sent into pipeline 400. Unit 410 passes object 1012 on, unit 420 caches object 1012. Process 900 terminates at 970, and control returns to step 620.

Driver interface module 220 issues a group end drawing command for object 1011. The type of command is discerned at step 630, and process 800 is executed. At step 810 candidate is FALSE, at step 830 group_count is decremented to 1, at step 840 parameters for group 1010 and num_objs_in_group (value 0) are popped out of the stack. At step 850 group_count is 1, at step 860 in_group_pipeline is FASLE. At step 865 pipeline 400 is flushed, resulting in unit 420 passing object 1012 to unit 430. Unit 430 attempts to remove group 1011, passes object 1012 to pipeline end 440, and object 1012 is passed to rendering engine 240. Process 800 terminates at 870, control returns to step 620.

Driver interface module 220 issues a group end drawing command for object 1010. The type of command is discerned at step 630, and process 800 is executed. At step 810, candidate is FALSE, at step 830 group_count is decremented to 0, at step 840 the stack is empty, at step 850 group_count is 0. At step 855 embedded_group is set to FALSE. At step 860 in_group_pipeline is FALSE. At step 865 pipeline 400 is flushed, process 800 terminates at 870, and control returns to step 620.

Driver interface module 220 issues a group start drawing command for object 1020. The type of command is discerned at step 630, and process 700 is executed. At step 710 in_group_pipeline is FALSE, at step 715 pipeline 400 is flushed. At step 720 group_count is incremented to 1. At step 730 group_count is 1. At step 760 group 1020 parameters are kept, process 700 terminates at 770, and control returns to step 620.

Driver interface module 220 issues a paint object drawing command for object 1021. The type of command is discerned at step 630, and process 900 is executed. At step 910 group_count is 1, at step 920 num_objs_in_group is incremented to 1, at step 930 num_objs_in_group is 1. At step 960 num_objs_in_group is 1 and embedded_group is FALSE. At step 962 candidate is set to TRUE, and at step 964 object 1021 is kept as a candidate. Process 900 terminates at 970, and control returns to step 620.

Driver interface module 220 issues a group end drawing command for object 1020. The type of command is discerned at step 630, and process 800 is executed. At step 810 the condition is satisfied, at step 820 in_group_pipeline is FALSE. At step 822 pipeline 500 is constructed and activated. At step 824 in_group_pipeline is set to TRUE. At step 826 object 1021 is sent into pipeline 500. Unit 510 passes object 1021 on, unit 520 attempts to remove group 1020, and unit 530 caches object 1021. At step 828 candidate is set to FALSE. At step 830 group_count is decremented to 0. At step 840 the stack is empty, at step 850 group_count is 0. At step 855 embedded_group is set to FALSE. At step 860 in_group_pipeline is TRUE. Process 800 terminates at 870, and control returns to step 620.

Driver interface module 220 issues a group start drawing command for object 1030. The type of command is discerned at step 630, and process 700 is executed. At step 710 in_group_pipeline is TRUE. At step 720 group_count is incremented to 1. At step 720 group_count is 1. At step 760 group 1030 parameters are kept, process 700 terminates at 770, and control returns to step 620.

Driver interface module 220 issues a paint object drawing command for object 1031. The type of command is discerned at step 630, and process 900 is executed. At step 910 group_count is 1. At step 920 num_objs_in_group is incremented to 1. At step 930 num_objs_in_group is 1, at step 960 the condition is satisfied. At step 962 candidate is set to TRUE, at step 964 object 1031 is kept as a candidate. Process 900 terminates at 970, and control returns to step 620.

Driver interface module 220 issues a group end drawing command for object 1030. The type of command is discerned at step 630, and process 800 is executed. At step 810 the condition is satisfied, at step 820 in_group_pipeline is TRUE. At step 826 candidate object 1031 is sent into pipeline 500. Unit 510 passes object 1031 on, unit 520 attempts to remove group 1030, unit 530 attempts to combine objects 1021,1031. AT step 828 candidate is set to FALSE. At step 830 group_count is decremented to 0. At step 840 the stack is empty, at step 850 group_count is 0, at step 855 embedded_group is set to FALSE. At step 860 in_group_pipeline is TRUE, process 800 terminates at 870, and control returns to step 620.

Driver interface module 220 issues a group start drawing command for object 1040. The type of command is discerned at step 630, and process 700 is executed. At step 710 in_group_pipeline is TRUE. At step 720 group_count is incremented to 1. At step 730 group_count is 1. At step 760 group 1040 parameters are kept, process 700 terminates at 770, and control returns to step 620.

Driver interface module 220 issues a paint object drawing command for object 1041. The type of command is discerned at step 630, and process 900 is executed. At step 910 group_count is 1. At step 920 num_objs_in_group is incremented to 1. At step 930 num_objs_in_group is 1. At step 960 the condition is satisfied. At step 962 candidate is set to TRUE, at step 964 object 1041 is kept as a candidate object, process 900 terminates at 970, and control returns to step 620.

Driver interface module 220 issues a paint object drawing command for object 1042. The type of command is discerned at step 630, and process 900 is executed. At step 910 group_count is 1. At step 920 num_objs_in_group is incremented to 2. At step 930 the condition is satisfied. At step 932 pipeline 500 is flushed. Unit 530 passes combined object 1021,1031 to pipeline end 540, and combined object 1021,1031 is passed onto rendering engine 240. At step 934 pipeline 400 is restored and activated. At step 936 in_group_pipeline is set to FALSE. At step 940 candidate is TRUE, at step 942 candidate object 1041 is sent into pipeline 400. Unit 410 passes 1041 on. Unit 420 caches object 1041. At step 944 candidate is set to FALSE, at step 950 object 1042 is sent into pipeline 400. Unit 410 passes object 1042 on. Unit 420 attempts to combine objects 1041,1042. Process 900 terminates at 970, and control returns to step 620.

Driver interface module 220 issues a group end drawing command for object 1040. The type of command is discerned at step 630, and process 800 is executed. At step 810 candidate is FALSE, at step 830 group_count is decremented to 0. At step 840 the group stack is empty, at step 850 group_count is 0, at step 855 embedded_group is set to FALSE. At step 860 in_group_pipeline is FASLE. AT step 865 pipeline 400 is flushed. Unit 420 passes combined object 1041,1042 on, unit 430 attempts to remove group 1040, pipeline end 440 is reached, and combined object 1041,1042 is passed to rendering engine 240. Process 800 terminates at 870, and control returns to step 620.

At the buffering step 620, no further drawing command are available, so at the pipeline flushing step 640 the pipeline 400 is flushed, resulting in all objects being passed to rendering engine 240, and the process 600 terminates at the END step 650.

The arrangements of FIGS. 2 to 10 therefore provide for the optimising of graphical processing by using idiom recognition to reduce or remove groups of objects, or the influence of groups of objects from the rendering pipeline.

### Merging Overlapping or Otherwise Proximate Glyphs

FIG. 11 is a schematic flow diagram for describing operation of a typical raster image processing system 1100 for example as implemented by the computer system 100 of FIG. 1. FIG. 11 shows an Application process 1101 which sends graphic objects to a Driver process 1102. The Driver process 1102 modifies the graphic objects and outputs a graphic object stream to Raster Image Processor (RIP) process 1103. The Raster Image Processor (RIP) process 1103 renders the graphic object stream into an image (e.g., for printing or displaying). The actual Application process 1101, and Raster Image Processor RIP process 1103 are not directly relevant to the present implementation and thus will not be described in further detail.

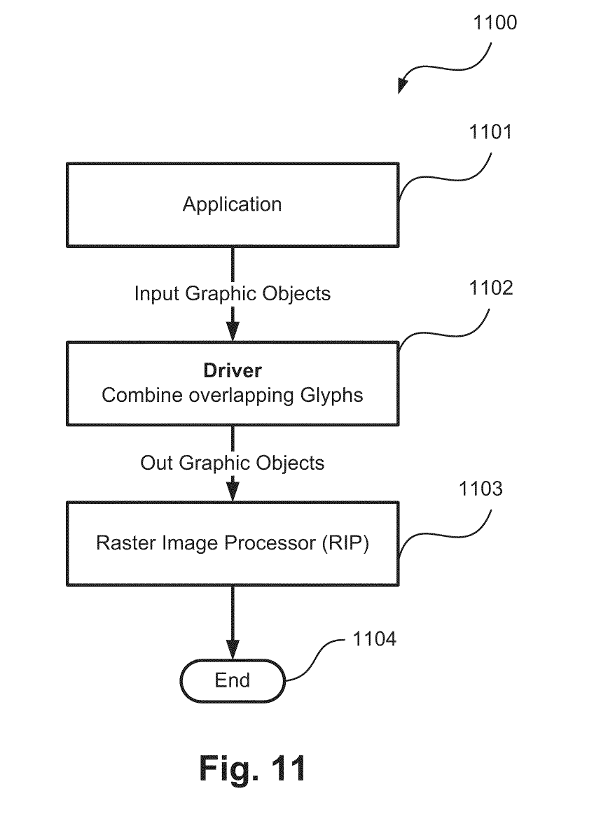

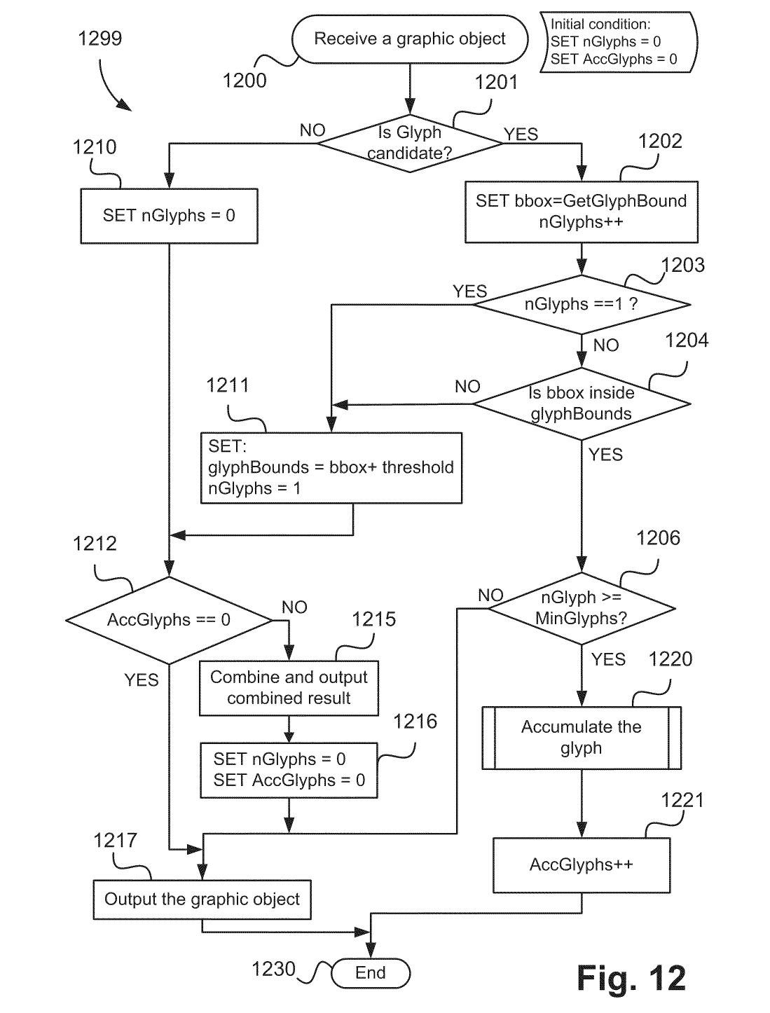

FIG. 12 is a schematic flow diagram describing a method 1299 of combining overlapping glyphs as performed in the Driver process 1102, for example as part of the application 133 executable by the processor 105. The input to the driver process 1102 is a graphic object from the Application process 1101. The method 1299 assumes the system has initialised two state variables: nGlyhs and accGlyphs to zero before the Driver process 1104 receives any graphic object. The state variables may be formed or stored in the memory 106 by the processor 105.

The method of FIG. 12 starts at step 1200 where a graphic object is supplied to the Driver process 1102 by the Application process 1101. Step 1201 then determines whether the graphic object is a candidate for combining overlapping glyphs. The graphic object is candidate for combining overlapping glyph if it is a glyph graphic object and:
(i) the fill pattern is opaque.
(ii) the associated ROP does not utilize the background colour.

If the graphic object is candidate for combining overlapping glyphs, then step 1202 is carried out, otherwise step 1210 is carried out.

In step 1202, the bounding box of the glyph graphic object is determined and stored in a temporary variable bbox, for example formed within the memory 106, and the state variable nGlyph is increased by 1.

Then, in step 1203, if the state variable nGlyph is has a value of 1, then step 1211 is carried out, otherwise step 1204 is carried out.

In step 1211, since the glyph graphic object is the first glyph detected, the state variable nGlyphs is set to 1, and a new state variable glyphBounds is set to be first glyph bounding box expanding with predetermined thresholds in top, left, right and bottom of the bounding box bbox. In an exemplary implementation, the bounding box is expanded by four hundred (400) pixels in all four directions. However, the expansion of the bounding box may be customised to any value in different directions, depending on experimentation or data collected during the printing process.

As a consequence of the setting of the boundaries of the glyphs and the associated bounding box expansion, as will become apparent in the following description, references in this description to “overlapping glyphs” is a reference to glyphs that overlap, or to glyphs that are in such proximity that their corresponding expanded bounding boxes overlap. The expansion of bounding boxes can cause overlap of the bounding boxes where the corresponding glyphs are spatially quite proximate, but in fact do not overlap. This expansion is useful as such accommodates minor changes in rendering resulting from dynamic graphical properties. For example, a word processing environment may automate management of text character spacing. In some instances therefore, rendering text with vector graphics may result in minor movement of individual text objects within a bound typically surrounding the actual text character shape over the vector graphic. Treating the multiple text glyphs as a single object is desirable. As such, rendering operations should desirably to accommodate such changes and in the present description this is achieved by expanding a bounding box of the associated glyph object by a predetermined threshold, (for example, 50 pixels) and then performing merging of the then overlapping bounding boxes. The threshold may be determined by experimentation and applied as a single threshold for a range of glyphs. Alternatively, the threshold may be determined for different object types, such that each different object type has a corresponding threshold. The present inventors have found that thresholds of between about 200 and 600 pixels provide appreciable improvements in rendering efficiency for a range of object types. In a specific implementation, the present inventors apply a single threshold criterion of 400 pixels for expanding the bounding box of an object in each of the four directions of the bounding box. For example, a glyph having a bounding box of size 300×700 pixels would have its corresponding proximity threshold bounding box enlargened (or expanded) to a size of 1100×1500 pixels.

In step 1204, if the bounding box bbox is inside the state variable glyphBound, step 1206 is carried out, otherwise step 1211 is carried out.

In step 1206, if the state variable nGlyphs is less than to a predetermined threshold MinGlyphs, step 1217 is carried out, otherwise step 1220 is carried out.

The predetermined threshold MinGlyphs is the minimum number of sequential glyph graphic objects observed in the graphic object. The overlapping glyph graphic objects subsequent to or after the predetermined threshold MinGlyphs overlapping glyph, will be combined in to a 1-bit depth bitmap mask. For example if MinGlyphs value is 2, and the overlapped glyph graphic object stream has glyphs A, B, C, D, E, F, G, and H, then only glyphs C, D, E, F, G, and H are combined into 1-bit depth bitmap mask.

In step 1220, the glyph graphic object is accumulated for combining into 1-bit depth bitmap mask.

Then in step 1221, state variable accGlyph is increased by 1, and then the method ends at step 1230.

In step 1210, the state variable nGlyphs is reset to zero, and step 1212 is then carried out.

Also after step 1211, in step 1212, if the state variable accGlyphs is zero, step 1217 is carried out, otherwise step 1215 is carried out.

In step 1215, the accumulated overlapping glyphs are combined into a 1-bit depth bitmap mask where the size of the 1-bit depth bitmap is at least equal the size of the expanded first glyph bounding box with the predetermined threshold, i.e., the size of the state variable glyphBounds. Methods for combining glyphs are well known in the art hence need not be described further in the present implementation. A new graphic object is constructed from the 1-bit depth bitmap and output to the RIP process 1103. There are two preferred ways of construct the new graphic object:

The first method is to create a new graphic object with:
the original ROP of the first glyph;
a fill path which traces the outline of “1” bits of the 1-bit depth bitmap mask where the bitmap is placed at the rectangle is the state variable glyphBounds; and
the graphic object shape is filled with the source original fill of the first glyph.

The second method is to create a new graphic object with:
a ROP3 0xCA operator,
a rectangular fill-path shape, where the rectangle is the state variable glyphBounds
the graphic object shape is filled with the source being the original fill of first glyph; and
the shape is filled with pattern consisting of the single 1 bit-per-pixel (bpp) bitmap mask.

After step 1215, in step 1216 the processor 105 resets the state variables nGlyphs and AccGlyphs to zero.

Then, in step 1217, the current graphic object is output to the RIP processor 1103. Then in step 1230, the method 1299 ends.

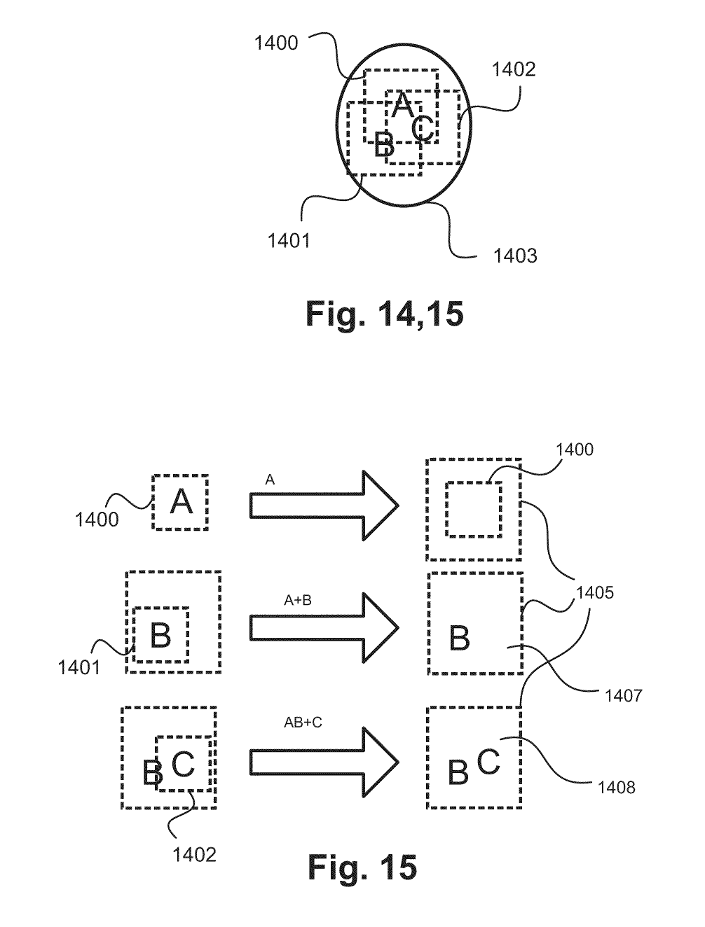

FIG. 14 shows an example of a graphic stream of 4 graphic objects which are listed in the following incremental priority order:
glyph A with bounding box 1400;
glyph B with bounding box 1401;
glyph C with bounding box 1402; and
a circle stroke path 1403.

The glyphs A, B, and C have COPYPEN ROP with opaque fill pattern.

It is also assumed that the predetermined threshold MinThreshold is set to one which means the first overlapping glyph will not be combined, i.e., only glyphs B and C will be combined together.

Now refer to FIG. 15, where initially the state variables nGlyph and AccGlyphs have been set to zero;

When the first graphic object, glyph A, is processed by the Driver 1102, since glyph A has COPYPEN ROP with opaque fill pattern, glyph A is a merged candidate, hence steps 1201 and 1202 are carried out. At step 1203, the state variable nGlyphs value is one, which is equal to one, and hence steps 1211 and 1212 are carried out. In step 1211, nGlyph is set to 1 and glyphBounds 1405, seen in FIG. 15, is set to be the bounding box of glyph A 1400 expanded by predetermined thresholds in left, right, top, and bottom directions. In step 1212, since the state variable AccGlyphs is zero, step 1217 is carried out which outputs the glyph A to the RIP 1103. Then the method 1102 ends at step 1230.

When the next graphic object, glyph B, with the bounding box 1401 is processed by the Driver 1102, since glyph B has COPYPEN ROP with opaque fill pattern, it is a merged candidate. Steps 1201, 1202, and 1203 are therefore carried out. In step 1203, the value of the state variable nGlyphs is two, which is not equal to one, and hence step 1204 is carried out. Also the bounding box 1401 of glyph B is inside glyphBounds 1405, then step 1206 is carried out. Furthermore, since nGlyphs is greater than one (MinGlyphs), step 1220 is carried out to accumulate the first accumulated glyph−glyph B. Then in step 1221, AccGlyph is increased to one. Then the method 1102 ends at step 1230.

The next graphic object, glyph C, with the bounding box 1402 is processed by the Driver 1102. Since glyph C has COPYPEN ROP with opaque fill pattern, it is a merged candidate, and steps 1201, 1202, and 1203 are therefore carried out. In step 1203, the value of the state variable nGlyphs is 3, which is not equal to 1, and hence step 1204 is carried out. Also, since the bounding box 1401 of glyph C is inside glyphBounds 1405, then step 1206 is carried out. Furthermore, because nGlyphs is greater than 1 (MinGlyhs), step 1220 is carried out to accumulate the first accumulated glyph−glyph C, then in step 1221, AccGlyph is increased to two. Then the method 1102 ends at step 1230.

When the next graphic object, the circle stroke path 1403, is processed by the Driver 1102, since circle stroke path 1403 is not a glyph object, step 1210 is carried out where nGlyph is set to zero. Then in step 1212, AccGlyphs is two, which is not zero, steps 1215 and 1216 are carried out. In step 1215, glyph B 1401, and glyph C 1402 are combined in to 1-bit bitmap 1408 and the combined result is output according to one of the two methods described above with reference to step 1215. Then in step 1217, the circle stroke path 1403 is output and the method 1102 ends at step 1230.

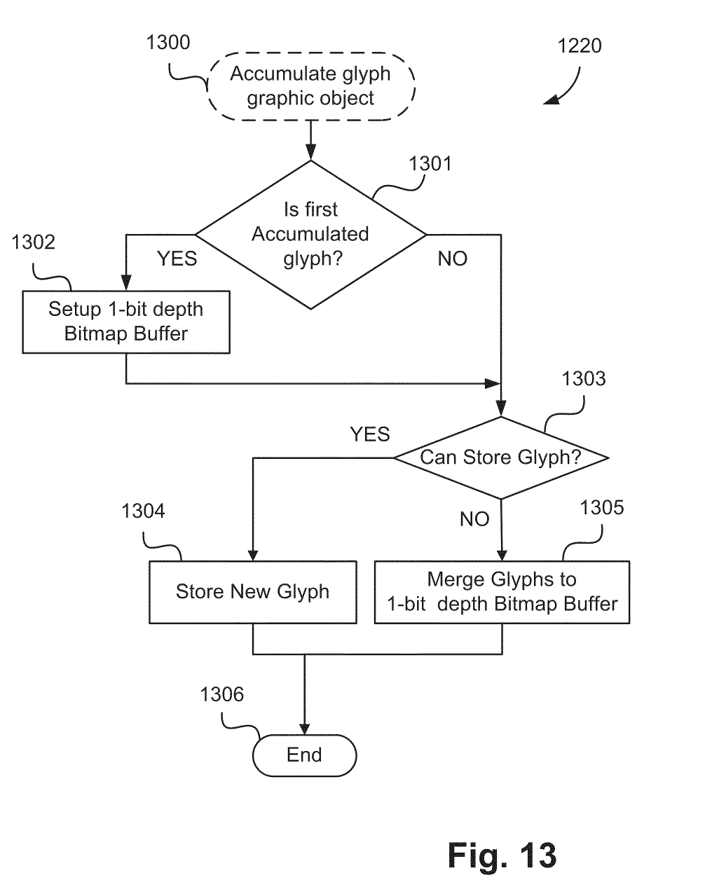

FIG. 13 is a schematic flow diagram of describing the method of accumulate glyph graphic object 1220 which was described in FIG. 12 where an input new glyph is to be accumulated.

The method 1220 of FIG. 13 has an entry at step 1300. In step 1301, if the input glyph is the first accumulated glyph, step 1302 is carried out, otherwise step 1303 is carried out.

In step 1302, a 1-bit depth bitmap buffer is allocated. The buffer is set to at least the same size as the bounding box of the first glyph expanded by the predefined thresholds, i.e. the rectangle glyphBounds. The 1-bit depth bitmap buffer is initialised to white value (for example the buffer data values are zero).

In step 1303, if the computer system 100 has enough memory resources to store the glyph, and the state variable AccGlyphs is below a predetermined accumulated threshold, then step 1304 is carried out, otherwise, step 1305 is carried out.

In step 1304, the new accumulated glyph is stored in an internal buffer, for example in the memory 106.

In step 1305, if stored accumulated glyphs exist, the stored accumulated glyphs are merged into the 1-bit depth bitmap buffer which was allocated in step 1302. The new accumulated glyph is also merged into the 1 bit-depth bitmap. The merged bitmap may then be re-stored to the memory 106 by the processor 105.

Still referring to FIG. 13, the predetermined accumulated threshold mention in step 1303 is used to control the limit how many accumulated glyphs the Driver 1102 can store in its internal buffer/display list. For example if the predetermined accumulated threshold is zero, the method 1220 does not store the new accumulated glyph and it always go through step 1305 to merge the new accumulated glyph to the 1-bit depth buffer;

Now recalling the example in FIG. 15, assuming the method 1102 has detected the bounding box glyphBounds 1405, the glyph objects are glyph B with bounding box 1401 and glyph C with the bounding box 1402 are accumulated in step 1220 of FIG. 12.

The first accumulated glyph object, glyph B with the bounding box 1401, is processed in method 1220. Steps 1201 and 1220 are processed to set up the 1-bit depth bitmap buffer which has the same size as the glyphBounds box 1405. Since it is assumed that the predetermined accumulated threshold is zero, step 1303 and 1304 are carried out which glyph B is merged into the 1-bit depth bitmap buffer 1407.

When the next accumulated glyph, glyph C with the bounding box 1402, is processed in method 1220, steps 1301 1303 are carried out since glyph C is not the first accumulated glyph. Since it is assumed that the predetermined accumulated threshold is zero, steps 1303 and 1304 are carried out by which glyph C is merged into the 1-bit bitmap buffer 1407, as shown in the 1-bit depth bitmap 1408.

Combine Text with Different Object Type

The implementation above described a method by which adjacent objects, such as text objects, may be combined to form a single object. The objects are typically overlapping, but otherwise are sufficiently and determinably spatially proximate that at least their corresponding bounding boxes overlap. Bounding boxes may be expanded according to a rule or threshold which may increase the incidence of overlap.

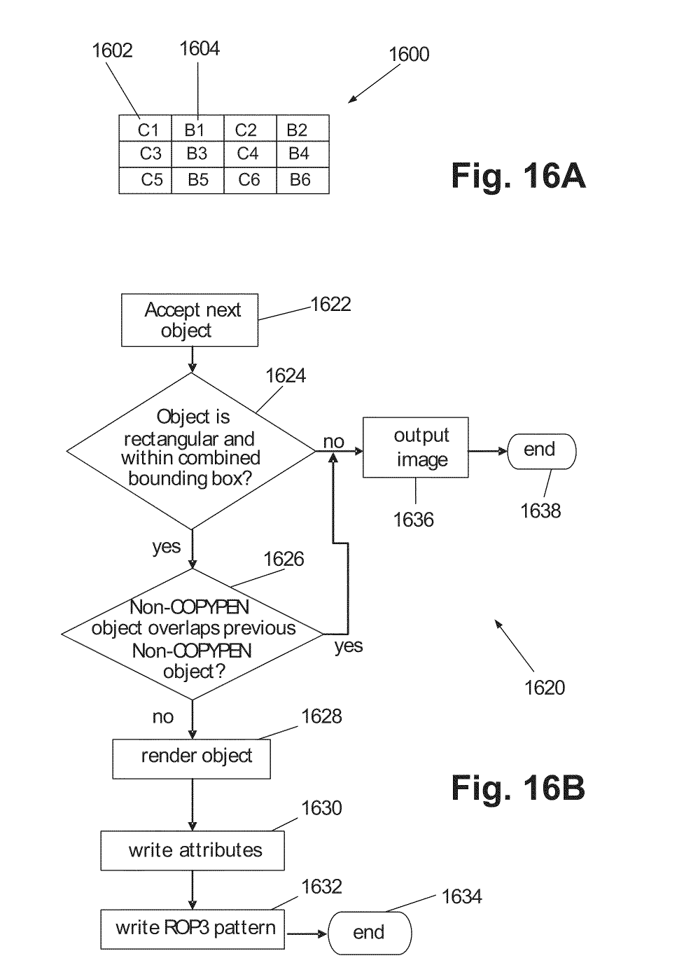

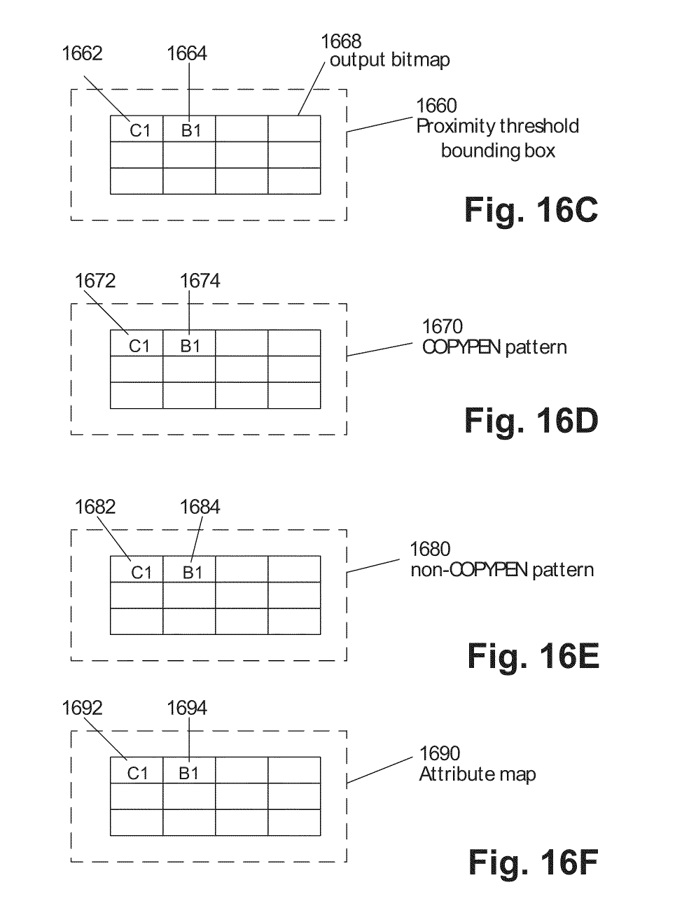

FIG. 16A is an example of a case where it is desirable to combine graphic objects of different graphical types. The objects may be text objects. In FIG. 16A, a checkerboard pattern 1600 is shown formed of a collection of generally different vector graphic objects 1602, drawn using a COPYPEN operator and labeled C1, C2 . . . C6. The objects 1602 are positioned in checkerboard fashion adjacent to different bitmap objects 1604, drawn using a XOR operator, and labeled B1, B2 . . . B6. A vector graphic object is typically authored in the PDL script as either vector graphics, or a type 3 font. The checkerboard pattern 1600 may include thousands of small, adjacent objects. Combining these thousands of small objects into a single bitmap can yield a significant speed improvement to downstream processing. It shall be noted that the processing described herein in relation to FIG. 16A apply in the case where the objects of FIG. 16A are fully opaque. The processing steps may be extended to handle transparency, with added complexity and processing costs.

FIG. 16B is a flowchart illustrating a process 1620 used to combine the objects of FIG. 16A. FIGS. 16C to 16F illustrate the outputs generated by the process of FIG. 16B. FIGS. 16B to 16F shall now be described by way of example with reference to FIG. 16A. The process 1620 is typically implemented as software stored in the HDD 110 and executed by the processor 105.

Particularly, the process 1620 to be described, produces for the (12) graphic objects of FIG. 16A, a single bitmap graphic object 1668 seen in FIG. 16C enclosed within a proximity threshold bounding box 1660. The process 1620 also produces ancillary data including a COPYPEN pattern 1670 of FIG. 16D, a non-COPYPEN pattern 1680 of FIG. 16E and an attribute map 1690 of FIG. 16F. The ancillary data is used by the subsequent rendering process to which the data of FIGS. 16C to 16F is to be input, to assist in rendering the bitmap object 1668, for example by specifying fill data, clip information, transparency attributes and the like, all of which may operate upon rendering to modify in some way the reproduction of the originally intended objects B1 . . . B6 and C1 . . . C6.

At commencement of the process 1620, each of the outputs 1660, 1670, 1680 and 1690, which are effectively buffers of data, are initialized with all bits set to zero.

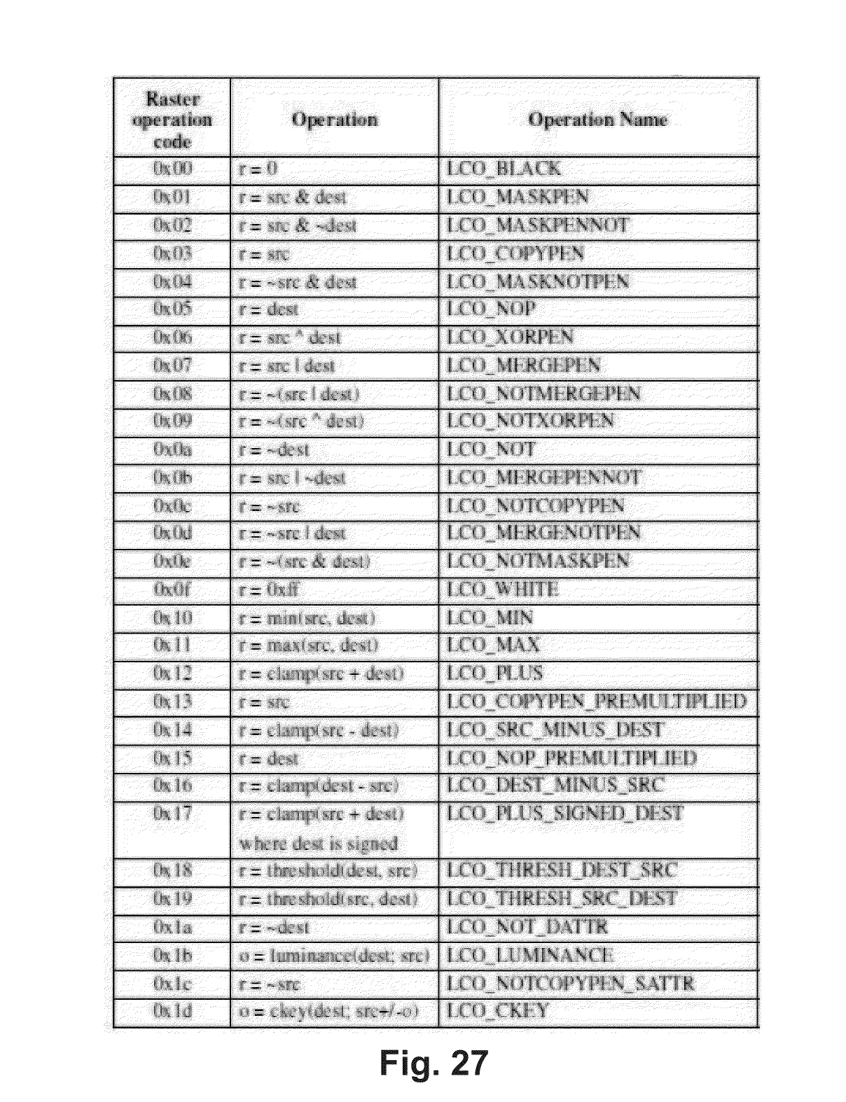

The process 1620 also makes use of raster operations (ROPs), for example those specified under the Microsoft Windows™ graphics device interface (GDI) to define how the GDI combines the bits in a source bitmap with the bits in a destination bitmap. Examples of such ROPs are shown in FIG. 27. Each function can be applied to each pair of color components of the source and destination colors to obtain a like component in the resultant color. ROP codes are typically specified in a hexadecimal format of the form 0xNN, where NN is a hexadecimal number. Examples of such ROP codes include 0x03 COPYPEN, 0x06 XORPEN, and 0x07 MERGEPEN in FIG. 27. Others, from Windows™ GDI, include 0xCA and 0x6A, and operators known in the art as ROP3 and ROP4. The present description makes specific use of the COPYPEN raster operation, and also refers to other raster operations as non-COPYPEN operations, for which the logical XOR function is one such example.

Referring to FIG. 16B, in step 1622, the first object 1602_C1 is received by the process 1620, for example by the processor 105 retrieving the object 1602 from the memory 106. In step 1624, a determination is made by the processor 105 of whether the received object 1602_C1 is rectangular, and whether the object 1602_C1 fits within a combined bounding box 1660, as seen in FIG. 16C. The combined bounding box 1660 represent a boundary enclosing all pixels to be rendered by the process 1620 operating on the objects 1602 and 1604. The location and dimension of the combined bounding box 1660 will typically be determined after identifying several objects within close proximity. A detailed method of such determination is described later in this document. It shall be noted that, at the cost of additional processing effort, the restriction that the object be rectangular may be relaxed. In the case where the received object does not satisfy the conditions of step 1624, the combined image and buffers of FIGS. 16C to 16F are output to downstream processing (e.g. rendering or rasterization) in step 1636.

One method of outputting to downstream processing useful in step 1636 includes the use of two drawing operations. A first such drawing operation uses the output bitmap 1668 as the source and the COPYPEN pattern 1670 of FIG. 16D as the ROP3 COPYPEN pattern for ternary raster operator 0xCA. A second such drawing operation uses the output bitmap 1668 as the source, and the non-COPYPEN pattern 1680 of FIG. 16E as the ROP3 non-COPYPEN pattern for ternary raster operator 0x6A. Alternately, where downstream processing supports the ROP4 operator, a single ROP4 drawing operator may be issued, using the output bitmap 1668 as the source, the COPYPEN pattern 1670 OR-ed with the non-COPYPEN pattern 1680 as the pattern, and the COPYPEN pattern 1670 as the mask, with the ROP4 operator in this example being 0xCA6A. Here, where the mask is “1”, ROP3 0xCA is applied, but where the mask is “0”, ROP3 0x6A is applied. All output drawing operations associate an attribute map 1690 of FIG. 16F with the source bitmap 1668.

The process 1620 then terminates at step 1638, for the object accepted at step 1622.

In the case where the conditions at step 1624 are satisfied, processing of the method 1620 continues to step 1626. At step 1626, the object 1602 is examined. In this example, the object 1602 uses a COPYPEN operator, the process 1620 continues to step 1626 which tests if a non-COPYPEN object overlaps a previous non-COPYPEN object. In this example, the object 1602 uses the COPYPEN operator and thus step 1626 determines “NO”. At step 1628 which follows, the object 1602 is rendered to the bitmap 1660, outputting pixels 1662 to the locations in the bounding ox 1660 corresponding to the input object 1602_C1. At step 1630, an object-type value, named attribute value, is written or output to locations 1692_C1 in the attribute map 1690 of FIG. 16F. Attribute values are used to retain information on the type of object, and are typically used in downstream processing such as post-render colour conversion and halftoning. For example, post-render colour conversion and halftoning will typically apply a sharpening algorithm for text objects, but a smoothing algorithm for bitmap or graphic objects.

At step 1632, the area covered by object 1602_C1, being the area 1672_C1, is modified in COPYPEN pattern buffer 1670. Buffer 1670 consists of a 1-bit-per-pixel pattern, representing a ROP3 0xCA operator, where a value of one corresponds to the “C” (COPYPEN) operator, whereas a value of zero corresponds to the “A” (no-op) operator. The buffer 1670 as noted above is initialized with all bits set to zero, thereby equivalent to no operation (no-op). Step 1632 therefore sets all bits in region 1672_C1 to one. Further, step 1632 sets corresponding bits in region 1682_C1 in buffer 1680 to zero. Process 1620 then terminates at step 1634.

Object 1604_B1 is then received, as the process 1620 begins at step 1622. The conditions at step 1624 are satisfied, as seen in FIG. 16C. At step 1626, object 1604_B1 is examined in order to determine whether it overlaps a previous non-COPYPEN object. This is done by checking whether any bits are set to one in the buffer 1680 corresponding to object 1604_B1 in the region 1684 of FIG. 16E. Step 1626 also checks whether the non-COPYPEN operator of the received object 1604_B1 is the same as a non-COPYPEN operator of any previous received object, such as the object 1602_C1. The case where the condition of step 1626 succeeds, means that the object received at step 1622 overlaps with a previously received non-COPYPEN object or that the object received at step 1622 uses a non-COPYPEN operator different from a non-COPYPEN operator previously received in step 1622. Where step 1626 succeeds, at step 1636 each of the buffers of FIGS. 16C to 16F are output for downstream processing, and the process 1620 terminates at step 1638.

It shall be noted that the check of step 1626 is necessary in order to obtain correct output. The XOR operator, being an example of a non-COPYPEN operator, in particular is non-associative. The result of two overlapping XOR operator-based objects therefore cannot be reliably obtained by simply combining the two objects together. The XOR operator-based objects must be combined with the background in z-order. As the process of FIG. 16B does not have access to the background, the process 1620 of FIG. 16B must be terminated via steps 1636 and step 1638, when non-COPYPEN overlapping objects are received. It shall be noted that the conditions at step 1626 can be extended to handle associative non-COPYPEN operators, such as the OR binary raster operator, also commonly referred to as MERGEPEN, in which case processing may continue to step 1628.

In the case where the conditions at step 1626 are satisfied, processing continues to step 1628. Object 1604 is then rendered into its corresponding region 1664 in FIG. 16C. In the case where the corresponding pixel position in buffer 1674 contains a one value, object 1604 pixels are combined into region 1664 by applying an XOR operator. In the case where the corresponding pixel position in buffer 1684 contains a zero value, object 1604 pixels are directly copied into region 1664. The effect of this approach is to increase the overall area using the COPYPEN, rather than the XOR operator. Downstream processing is typically much faster in processing the COPYPEN operator than other raster operators. such as XOR.

At step 1630, the attribute values corresponding to image object 1604 are output to the region 1694. At step 1632, a value of one is output into region 1684, corresponding to each pixel in the region 1664, where there is currently a value of zero in the corresponding location in the region 1684. Similar to the pattern buffer 1670, the buffer 1680 consists of a 1-bit-per-pixel pattern, representing a ROP3 0x6A operator, where a value of one corresponds to the “6” (XOR) operator, whereas a value of zero corresponds to the “A” (no-op) operator.

Process 1620 then terminates at step 1634. Process 1620 is then typically executed for each remaining object, until a condition is encountered which triggers the process to terminate at step 1638.

Although the example described above is in relation to the XOR raster operator as the non-COPYPEN operation, the described method is readily extended to handle a plurality of other raster operators, such as those listed in FIG. 27. The described method is also readily extended to support optimizations, such as simplifying the operators drawn to downstream processing when all incoming objects have the same object type, for example when the pattern buffer 1670 consists entirely of zeros, or the pattern buffer 1680 consists entirely of zeros. If the pattern buffer 1670 is all zeros, it is not necessary to issue the ROP3 0xCA drawing command. The same situation applies where the buffer 1800 is all zeros.

In other implementations, it is possible to execute the processing described in FIG. 16B, by storing and merging the boundaries of objects received in step 1622, and later translating the object boundaries to one-bit-per-pixel ROP3 patterns in the buffers 1670 and 1680. An advantage arising from applying such a translation at a later stage is a reduction in the number of computationally expensive bit bashing operations applied to the buffers 1670 and 1680. Similarly, writing of pixels into buffer 1660 for objects containing a single colour only may be delayed until such time that accessing the object colour is required, such as when there is an XOR operation using varying pixel values.

### Trend Analysis for any Graphics Object

The above method provides for a configurable number of graphics objects within a configurable threshold proximity to be identified within the proximity bounding box before the algorithm or process of FIG. 16B is invoked to combine further text graphics objects into a single bitmap. This approach is also seen in FIG. 28 as described above.

The technique described above of observation or identification and consequential delayed algorithmic invocation is hereby referred to as “trend analysis”. The application of trend analysis was described in relation to FIGS. 12 to 15 for the combination of text graphics objects. However, the trend analysis method is not limited only to text graphic objects. A trend analysis method can be applied to the combination of any type of graphic objects within configurable threshold proximity, for example, vector-based graphic objects and bitmap objects.

The object combination processes of FIGS. 12 to 16 and the trend analysis method, when applied together, require at least two parameters: a threshold proximity bounding box, and a threshold number of objects to observe or identify prior to activation of the combination process.

The threshold proximity bounding box and the threshold number of objects to observe prior to activation of a combination process may be determined in number of ways. A first approach is through experimentation in a laboratory environment through statistical observation of graphic object clustering in a test set of pages. One such technique is to start with an initial size of the threshold proximity bounding box upwardly bound by expected memory limitations of the computing system in which the object combination is to be performed, with consideration that the size of the bounding box bounds the size of the combined bitmap that will be produced as a result of the combine operation. Statistical observation may then vary the size of the bounding box, and determine the number of objects contained within each bounding box size. The goal is to find the smallest threshold bounding box that still contains a large number of objects. In this fashion, the bounding box defines those overlapping objects desired to be combined and where rendering efficiencies may be obtained by the combining, and limiting the size of the bounding box optimizes the ability of the computing system to render both the overlapping objects and other non-overlapping objects in the image.

Similarly, statistical observation may be applied to determine the threshold number of objects to observe prior to activation of the object combine process. Such analysis can typically plot, given an initial “n” number of objects within the determined threshold proximity bounding box, the average number of total consecutive objects within the threshold proximity bounding box. The goal is to find the smallest “n” that still captures a large average number of total consecutive objects within the threshold proximity bounding box.

The threshold proximity bounding box may therefore be typically specified using resolution independent units, such as points, and hard-coded into a printer driver product. The printer driver implementation typically converts the specified threshold proximity bounding box into the device resolution of the printer, using the printer device's dots-per-inch property, prior to applying trend analysis and object combination algorithms.

It is possible to determine a plurality of threshold proximity bounding boxes, corresponding to different object types. For example, through statistical analysis, it may be determined that a smaller threshold proximity bounding box is assigned to text graphic objects, than the threshold proximity bounding box assigned to bitmap graphic objects.

Alternately, a printer driver, in product, may be configured with an initial threshold proximity bounding box and threshold number of objects to observe prior to activation of combine algorithm. The printer driver may then apply further statistical observation on the drawing commands of real-world jobs at customer premises in order to dynamically adjust and apply new, more effective thresholds to establish those drawing commands that may be combined.

Other approaches to trend analysis include dynamic and adaptive approaches. For example, trend analysis software may be configured in a printer to observe the nature of documents being printed over a period of time (e.g. one day) and the average time taken to print pages of those documents. Having determined a statistical basis, the relevant thresholds may be established, set or otherwise adjusted such the combination processes described herein may be implemented within the printer upon the stream of input graphics provided to the printer for hard copy reproduction. Subject to the trend analysis processing capacity of the printer, these adjust could be performed once per day (e.g. after core office hours), at predetermined intervals (eg. every one hour), or perhaps on a document-by-document basis subject to the document size and graphical complexity.

### Method of Optimizing a Stream of Graphic Objects

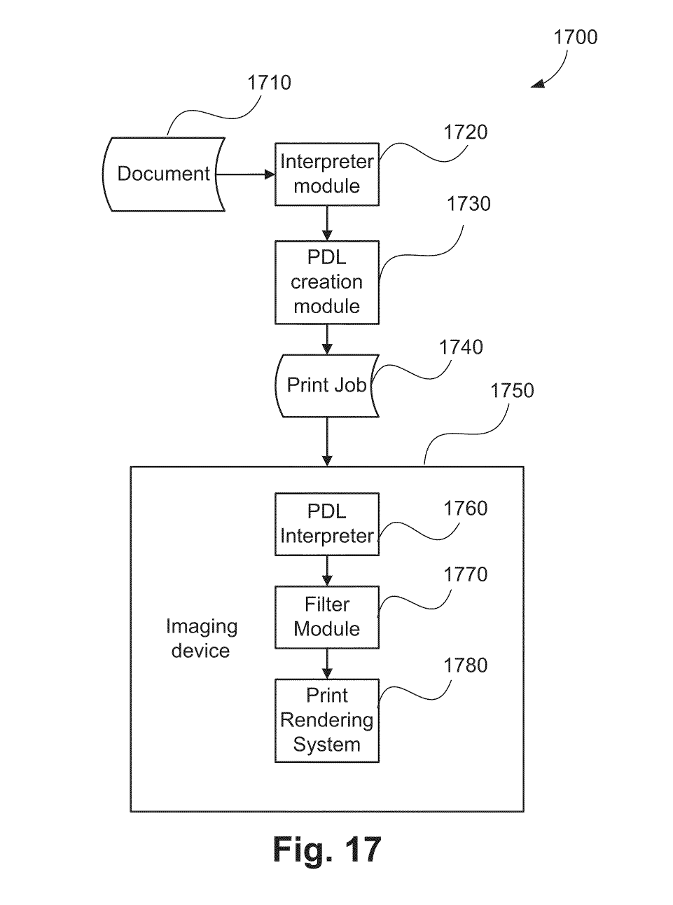

A schematic representation of a printing system 1700, for example implementable in the system 100 of FIG. 1, is illustrated in FIG. 17. An Interpreter module 1720 parses a document 1710 and converts the objects stored in the document 1710 to a common intermediate format. Each object is passed to the PDL creation module 1770. The PDL creation module 1770 converts object data to a print job 1740 in the PDL format. The job is sent to the Imaging device 1750 which contains a PDL interpreter 1760, Filter module 1770 and Print Rendering System 1780 to generate a pixel-based image of each page at “device resolution”. (Herein all references to “pixels” refer to device-resolution pixels unless otherwise stated). The PDL interpreter 1760 parses the print job 1740 and converts the objects stored in the print job to a common intermediate format. Each object is passed to the Filter Module 1770. The Filter Module 1770 coalesces candidate object data and generates a coalesced object in the common intermediate format, which is passed to the Print Rendering System 1780. In general purpose computing environments, the document 1710 is generated by a software application 133, with the modules 1720-1730 typically being implemented in software, generally executed within the computer module 101.

The Imaging Device 1750 is typically a Laser Beam or Inkjet printer device. The PDL Interpreter module 1760, Filter module 1770, and Print Rendering System 1770 are typically implemented as software or hardware components in an embedded system residing on the imaging device 1750. Such an embedded system is a simplified version of the computer module 101, with a processor, memory, bus, and interfaces, similar to those shown in FIG. 1. Significantly, the modules 1760-1780 are typically performed in software executed within the embedded system of the imaging deice 1750. In some implementations, the rendering system 1780, may at least in part, be formed by specific hardware devices configured for rasterization of objects to produce pixel data.

The Interpreter module 1720 and PDL creation module 1730 are typically components of a device driver implemented as software executing on a general-purpose computer module 101. One or more of PDL Interpreter module 1760, Filter module 1770, and Print Rendering System 1780 may also be implemented in software as components of the device driver residing on the general purpose computer module 101.

### “Object”

In the common intermediate format, a graphic object comprises:
path—the boundary of the object to fill;
   e.g. a string of text character glyphs, set of Bézier curves, set of straight lines . . .
clip—the region to which the path is limited;
operator—the method of painting the pixels;
   e.g. a Porter and Duff operator, ROP2, ROP3, ROP4, . . .
operands—the fill information (source, pattern, mask);
   e.g. source or pattern: Flat, Image, Tiled Image, Radial blend, 2pt blend, 3pt blend . . .
   e.g. mask may be a 1 bit per pixel image or a contone image containing alpha.

### Module Overview

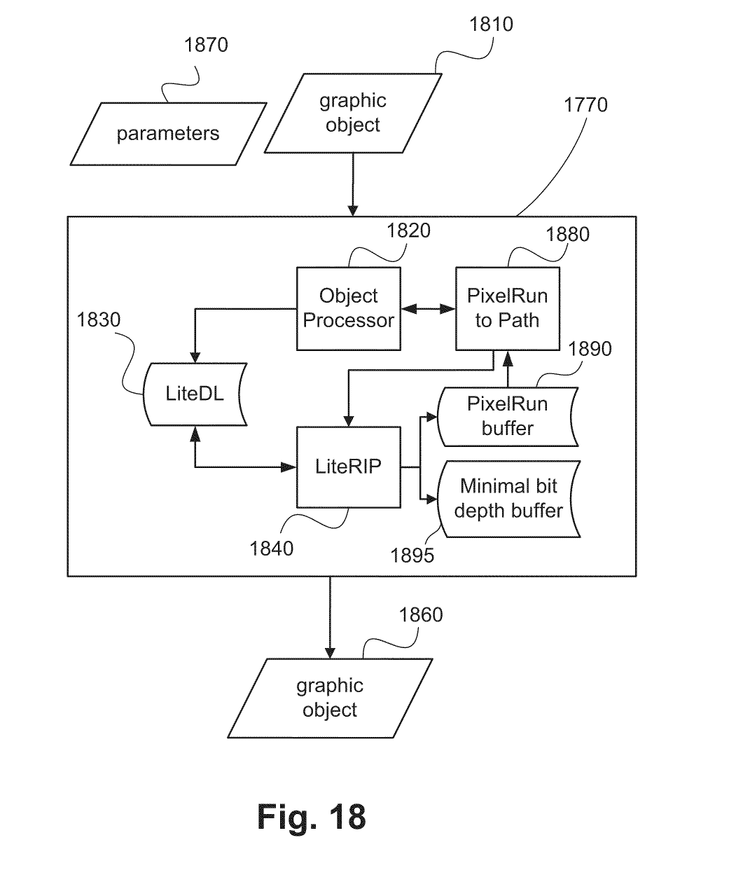

The following description refers to FIG. 18 which is a module diagram of the components of the filter module 1770.

The filter module 1770 is initialised with a set of parameters 1870, indicating various per-object and coalesced object thresholds.

An appropriate per-object threshold may be the maximum allowable size of the bounding box in pixels. For example, if this value is set to 1,000,000, then a graphic object is a candidate if its bounding box width multiplied by its height is less than or equal to 1,000,000 pixels.

An appropriate coalesced-object threshold may be the maximum allowable size of a coalesced object in pixels. For example, if this value is set to 4,000,000, then no more graphic objects are accepted by the Filter module 1770 when the bounding box which is the union of each accepted graphic object's bounding box has width multiplied by height greater than 4,000,000 pixels.

The parameters may be set by the designer of the device driver, or by the designer of the imaging device 1750 or by the user, either at print time from a user interface dialog box, or at installation time when the device driver is installed on the host computer, or at start-up time when the imaging device is switched on.

The filter module 1770 receives a stream of graphic objects 1810 from the PDL interpreter module 1760 conforming to the common intermediate format specification, and outputs a visually equivalent stream of graphic objects 1860 conforming to the same common intermediate format specification.

The filter module 1770 in FIG. 18 is seen to be formed of:

(i) an Object Processor 1820,

(ii) a minimal functionality raster image processor module, herein called LiteRIP 1840,

(iii) a minimal functionality display list store, herein called LiteDL 1830,

(iv) a Minimal bit depth buffer 1895, for example implemented in the memory 106, which stores the visible pixels of the coalesced image output by the LiteRIP module 1840 during rendering,

(v) a PixelRun buffer 1890, which stores pixel-run tuples {x, y, num_pixels} describing a span of visible pixels of the coalesced image output by the LiteRIP module 1840 during rendering, and

(vi) a PixelRun to Path module 1880, which consumes pixel-run tuples produced by the LiteRIP module 1840 and generates a path outline describing the visible pixels of the coalesced image stored in the Minimal bit depth buffer 1895.

### Object Processor

The Object Processor 1820 detects candidate graphic objects which satisfy per-object criteria as set by the parameters 1870. A stream of graphic objects which satisfies per-object criteria are added to the LiteDL 1830. When a graphic object in the stream no longer satisfies per-object criteria, the PixelRun to Path module 1880 is invoked to generate a path describing the coalesced region, and a minimal bit depth operand which contains the pixel values of the coalesced region.

The PixelRun to Path module 1880 invokes the LiteRIP module 1840 which renders the objects currently stored in the LiteDL 1830 and outputs pixel-run tuples {x, y, num_pixels}, hereafter referred to as pixel-runs, to the PixelRun buffer 1890 and pixel values to the Minimal bit depth buffer 1895. When the LiteDL 1830 has been fully consumed, the resulting object, called a RenderObject, is passed to the Print Rendering System 1780.

A RenderObject is a graphic object representing the coalesced graphic objects, where:

the path is an odd-even path exactly describing the pixels emitted when rendering the LiteDL 1830. This path is constructed by the PixelRun to Path module 1880 from the pixel runs generated by the LiteRIP module 1840 stored in the PixelRun buffer 1890;

the source operand is an opaque flat or image operand; and

the operator is a COPYPEN operation, requiring only a single source operand.

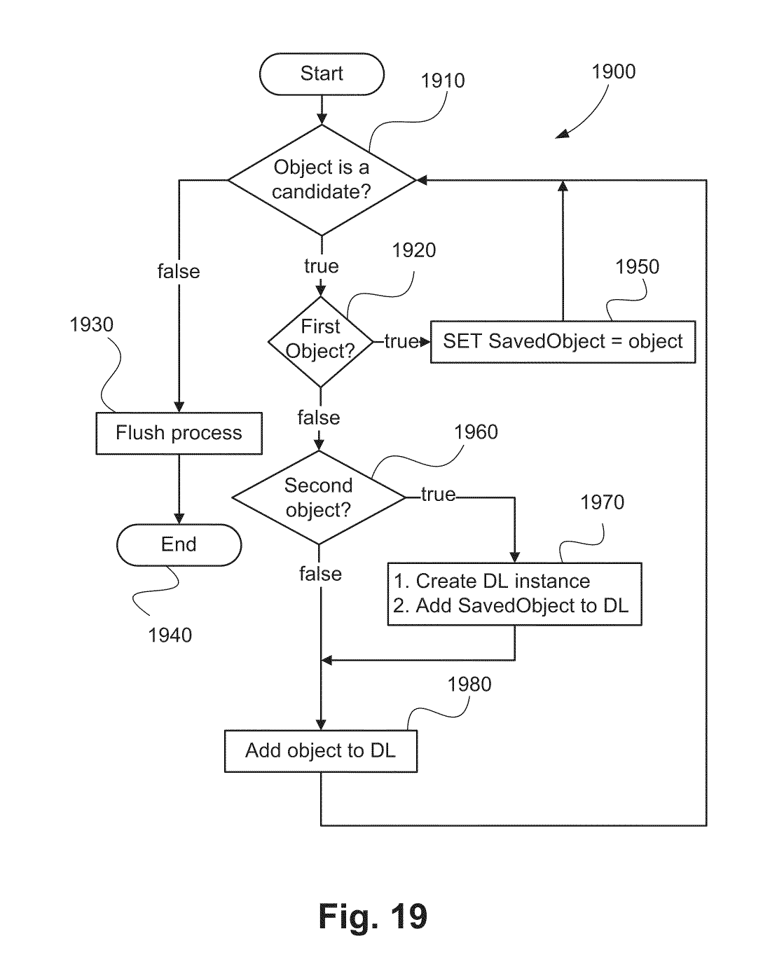

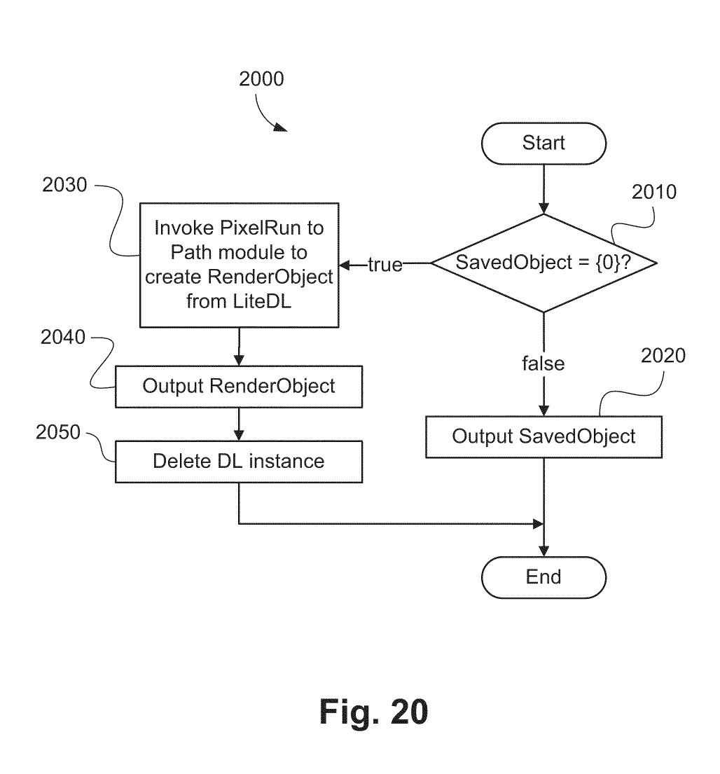

The flowchart of FIG. 19 illustrates a process 1900 for adding graphic objects 1810 to the LiteDL 1830. At step 1910 if an object is a candidate for coalescing then execution proceeds to step 1920. Otherwise execution proceeds to step 1930. At step 1920, if the object is the first candidate object, then execution proceeds to step 1950 otherwise execution proceeds to step 1960. At step 1950 the object is saved in the Object Processor 1820 and execution proceeds to step 1910 where the next object is examined. At step 1960 if the object is the second candidate object, then execution proceeds to step 1970 otherwise execution proceeds to step 1980. At step 1970 a new instance of a LiteDL 1830 is created and the object saved in step 1950 is added to LiteDL 1830. Execution proceeds to step 1980. At step 1980 the current object is added to the display list which was created at step 1970. Execution then proceeds to step 1910 where the next object is examined. At step 1910 if the current object has been detected as not being a candidate for coalescing execution proceeds to step 1930 where the stored objects are coalesced and flushed. The flush process 1930 is described in more detail in the flowchart of FIG. 20. The process terminates at step 1940.

The flowchart of FIG. 20 illustrates a process 2000 for flushing the accumulated graphic object data to the Print Rendering System 1780. At step 2010 if an object was saved but not yet added to the LiteDL 1830, then execution proceeds to step 2020 where SavedObject is emitted to the Print Rendering System 1780 and the process terminates. Otherwise execution proceeds to step 2030 whereby at this stage, at least two objects have been added to the LiteDL 1830. At step 2030 the PixelRun to Path module 1880 is invoked to create a coalesced object from the LiteDL 1830 using the LiteRIP module 1840. The coalesced object is stored in a RenderObject data structure. At step 2040 the RenderObject is emitted to the Print Rendering System 1780 and execution proceeds to step 2050. At step 2050, the DL instance created at step 1970 is deleted and the process terminates.

LiteRIP module

The LiteRIP module 1840, and LiteDL 1830 are preferably implemented using pixel sequential rendering techniques. The pixel-sequential rendering approach ensures that each pixel-run and hence each pixel is generated in raster order. Each object, on being added to the display list, is decomposed into monotonically increasing edges, which link to priority or level information (see below) and fill information (i.e. “operand” in the common intermediate format). Then, during rendering, each scanline is considered in turn and the edges of objects that intersect the scanline are held in increasing order of their points of intersection with the scanline. These points of intersection, or edge crossings, are considered in order, and activate or deactivate objects in the display list. Between each pair of edges considered, the colour data for each pixel that lies between the first edge and the second edge is generated based on the fill information of the objects that are active for that span of pixels. This span of pixels is called a pixel run and is typically represented by the tuple {x, y, num_pixels}, where x is the integer position of the starting edge in the pair of edges on that particular scanline, y is the scanline integer value, and num_pixels is the distance in pixels between the starting edge and ending edge in the pair of edges.

In preparation for the next scanline, the coordinate of intersection of each edge is updated in accordance with the properties of each edge, and the edges are re-sorted into increasing order of intersection with that scanline. Any new edges are also merged into the list of edges, which is called the active edge list. Graphics systems which use pixel sequential rendering have significant advantages in that there is no pixel frame store or line store and no unnecessary over-painting.

In an exemplary implementation, LiteRIP 1840 is implemented with a subset of the functionality common in state of the art raster image processors. In particular:

(i) compositing functionality is typically limited to operations requiring only source, and pattern operands. For example, a binary raster operation such as DPo (known as MERGEPEN), which requires bitwise OR-ing the source object with the destination surface.

(ii) source and pattern operands are typically limited to:
flat (also known as “solid”) fills,
1, 4 or 8 bit-per-pixel indexed images, and
8-bit-per-channel “contone” image data.

(iii) path data is typically limited to fill-paths consisting of straight line segments.

Graphic objects satisfying the above functionality are prevalent in legacy applications and archived print jobs created by legacy applications. By limiting functionality to the above subset, LiteRIP 1840 is able to specialize in coalescing large numbers of simple legacy graphic objects while expeditiously ignoring highly functional graphic objects, such as Beziers filled with radial gradations, or stroked text objects filled with multi-stop linear gradations.

### Display List Store

When an object is added to the LiteDL 1830, it is preferably decomposed by the Object Processor 1820 into three components:

(i) Edges, describing the outline of the object;

(ii) Drawing information, describing how the object is drawn on the page; and

(iii) Fill information, describing the source and pattern of the object.

Outlines of objects are broken into up and down edges, where each edge proceeds monotonically down the page. An edge is assigned the direction up or down depending on whether it activates or deactivates the object when scanned along a row.

An edge is embodied as a data structure. The edge data structure typically contains:

(i) points describing the outline of the edge,

(ii) the x position on the current scanline, and

(iii) edge direction.

Drawing information, or level data, is stored in a data structure called a level data structure. The level data structure typically contains:

(i) Z-order integer, called the priority,

(ii) fill-rule, such as odd-even or non-zero-winding,

(iii) information about the object, such as if the object is a text object, graphic object or image object,

(iv) compositing operator,

(v) the type of fill being drawn, such as an image, tile, or flat colour, and

(vi) clip-count, indicating how many clips are clipping this object. This is described in more detail below.

Fill information, or fill data, is stored in a data structure called a fill data structure. The contents of the data structure depend on the fill type. For an image fill, the fill data structure typically contains:

(i) x and y location of the image origin on the page,

(ii) width and height of the image in pixels,

(iii) page-to-image transformation matrix,

(iv) a value indicating the format of the image data, (for example 32 bpp RGBA, or 24 bpp BGR, etc . . . ),

(v) a pointer to the image data,

(vi) a pointer to the color table data for indexed images, and

(vii) a Mapping Function for indexed image operands. This is described in more detail below.

For a flat fill, the data structure contains an array of integers for each colour channel.

In a typical implementation, a LiteDL 1830 is a list of monotonic edge data structures, where each edge data structure also has a pointer to a level data structure. Each level data structure also has a pointer to a fill data structure.

### Minimal Bit-Depth Operand

One aspect of the present disclosure is a method of generating a minimal bit-depth operand. A minimal bit-depth operand is advantageous because it significantly reduces the amount of image data required by the Filter Module 1770 and the Print Rendering System 1780. For example, if the LiteDL 1830 contains a single color, such as red, then LiteRIP 1840 can generate a RenderObject with a red flat fill operand. In another example, if the LiteDL contains two colors, such as red and green, then LiteRIP can generate a RenderObject with a 1 bit-per-pixel indexed image and a color table consisting of the two entries: red and green.

Typically a RIP generates a contone (continuous tone) image. A post-processing step may then attempt to reduce the contone image to an indexed image, or the contone image may even be compressed. Such methods require large amounts of memory and compression is time-consuming, ultimately requiring the additional step of decompression. Such methods are inferior to the method of directly generating a minimal bit-depth operand as described herein.

The generation of a minimal bit-depth operand is achieved by the use of a Mapping Function, which is stored with each flat operand or indexed image operand in the LiteDL 1830. The Mapping Function maps input pixel values to output pixel values corresponding to the bit-depth of the resulting minimal bit-depth operand.

In an exemplary implementation, the Mapping Function is implemented as a look-up table. FIG. 21 is a flowchart describing a process 2100 for the creation of the Mapping Function for any operand. The variable Fill is the input source or pattern operand being added to the LiteDL 1830, which may be a flat operand, an indexed image operand or a contone (non-indexed) operand.

The variable ColorLUT is an array of color values which are known to exist in the LiteDL.

The variable TotalColors is the number of entries in ColorLUT.

The variable Map, being the Mapping Function, is an array which specifies:

(i) for an indexed image operand how the pixel values of the indexed image map to the pixel values of the output image, and

(ii) for a flat operand, the pixel value to write to the output image operand, stored at index 0.

The variable MaxColors is the maximum number of colors that can be stored in ColorLUT. This is typically a power of two and represents the largest preferred bit-depth of the final operand. A contone image can always be generated by LiteRIP 1840.

For example, if MaxColors is two, then LiteRIP 1840 may generate a contone image or a 1 bit-per-pixel indexed image. If MaxColors is sixteen, then depending on the final value of TotalColors, LiteRIP 1840 may generate a contone image, or a one bit-per-pixel (bpp), two bpp or four bpp indexed image. When LiteRIP 1840 generates an indexed image, ColorLUT is used as the color table associated with the generated indexed image.

If the LiteDL 1830 receives a contone image operand, then TotalColors is immediately set to MaxColors+1, since the resulting operand must also be a contone image operand. Otherwise, the process 2100 is executed.

At step 2110, ColorLUT, TotalColors and Map are initialised to zero. At step 2120, if TotalColors is less than or equal to MaxColors then execution proceeds to step 2130 otherwise the process is terminated. At step 2130, loop variable I is set to zero and execution proceeds to step 2140. At step 2140, if loop variable I is less than the number of colors in Fill, then execution proceeds to step 2150, otherwise all colors in Fill have been examined and the process terminates. At step 2150, C is set to the current color in Fill to be examined. For a flat operand, Fill.nColors=1, and Fill.Color0 is the actual flat color, such as “red”. For an indexed operand, this is the I^{th} entry in the indexed image color table. For example, if a one bpp indexed image has a color table with first entry red, and second entry orange, then Fill.nColors is two, Fill.Color0 returns red, and Fill.Color1 returns orange. Additionally at step 2150, color C is searched in the ColorLUT. If C is found, then variable J is set to the index into the ColorLUT array where C resides. Otherwise, if there is room in the ColorLUT, then variable J is set to the first empty location. At step 2160, if C was found in ColorLUT, then execution proceeds to step 2195 otherwise execution proceeds to step 2170. At step 2170 TotalColors is incremented by one. At step 2180, if TotalColors is less than or equal to MaxColors, then execution proceeds to step 2190 otherwise the process is terminated. At step 2190, C is stored in location ColorLUTJ and execution proceeds to step 2195. At step 2195, the value J is stored in the Mapping Function at index I, MapI=J, and I is incremented by one. Execution continues to step 2140 until the process terminates.

### Example for Mapping Function

As an example of the use of the Mapping Function, consider the following scenario of three objects being added to the LiteDL 1830. MaxColors is sixteen, meaning LiteDL 1830 can potentially output a four bpp indexed image with a 16 entry color table.

Object0 has a source fill, Fill0 which is a 1 bpp indexed image and has a color table with entry 0 set to red, and entry1 set to green. Fill0.nColors=2.

By following the process 2100, it can be seen that at step 2190, for each color {red, green}, the color is added to the ColorLUT, such that ColorLUT0=red and ColorLUT1=green. At the end of processing Fill0:
TotalColors=2
ColorLUT is {red, green}, and
Map0 assigned to Fill0 is {0, 1}.

Object 1 has a source fill, Fill1 which is a flat operand, green. Fill1.nColors=1. At step 2150, C is set to green and C is found in ColorLUT at index 1. J is set to 1. At step 2160, C was found in ColorLUT so at step 2195, Map0 is set to 1. Execution is terminated at step 2199 since all colors have been processed. By following the process 2100, it can be seen that:
TotalColors=2
ColorLUT is {red, green}, and
Map1 assigned to Fill1 is {1}.

Object 2 has a source fill, Fill2 which is a 2 bpp indexed image, color table has entries {blue, green, red, orange}. By following the process 2100, it can be seen that:
TotalColors=4
ColorLUT is {red, green, blue, orange}, and
Map2 corresponding to Fill2 is {2, 1, 0, 3}.

If the LiteDL 1830 is now rendered, then since TotalColors=4, which is less than or equal to MaxColors (16), LiteRIP 1840 can generate a two bpp indexed image, with a color table equivalent to ColorLUT.

During rendering,
when the 1 bpp image Fill0 is emitted, pixel values corresponding to bit 0 are emitted through Map00 and pixel values corresponding to bit 1 are emitted through Map01;
when the flat Fill1 is emitted, pixel values are emitted through Map10, since the operand is a flat; and
when the two bpp image Fill2 is emitted, pixel values of zero are emitted through Map20, pixel values of 1 are emitted through Map21, pixel values of 2 are emitted through Map22, and pixel values of 3 are emitted through Map23.

The ability of the Filter module 1770 to efficiently generate a minimal bit depth operand significantly reduces the image-processing load on the print rendering system 1780.

### Twofold Output of LiteRIP

As described previously, the LiteRIP module 1840 emits two sets of data for each span of pixels:

(1) pixel-runs {x, y, num_pixels}, which are output to the PixelRun buffer 1890, and

(2) pixel-values, which are output to the pre-allocated Minimal bit depth buffer 1895.

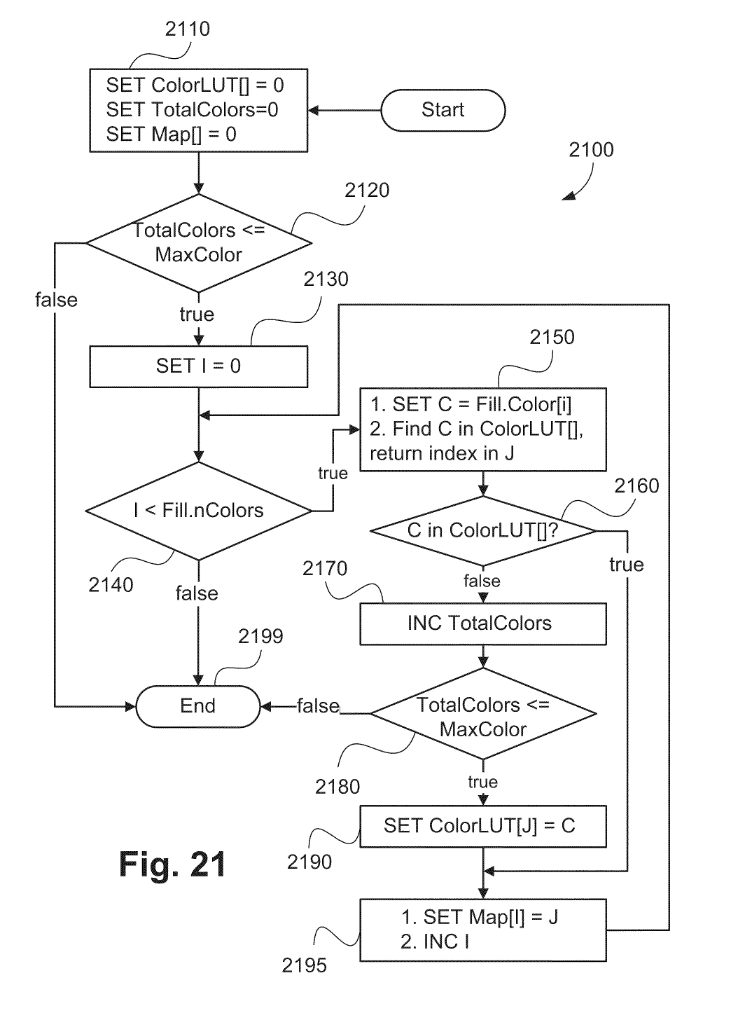

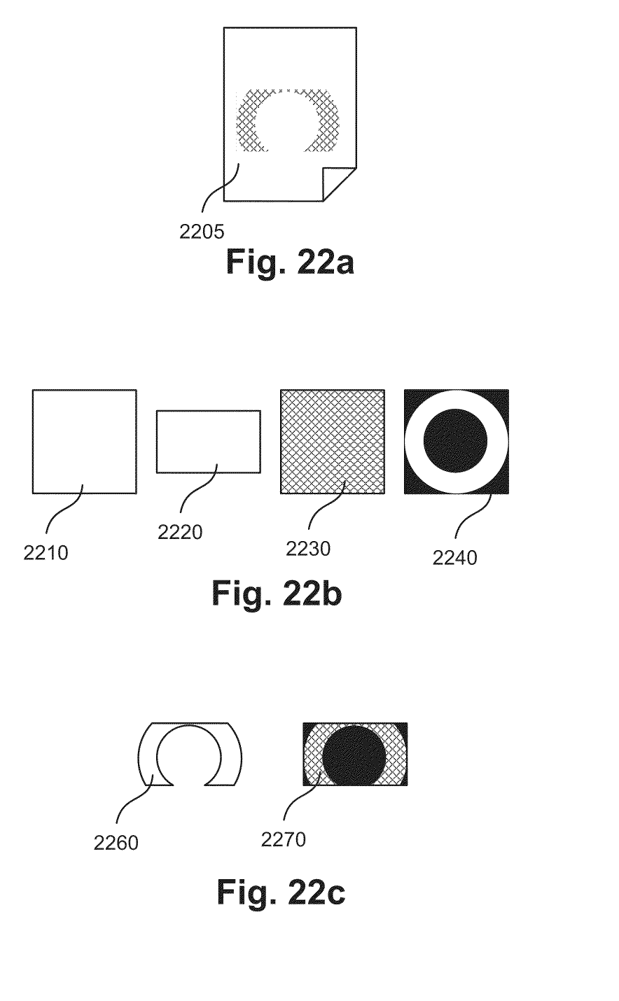

When a graphic object includes both a source operand and a pattern operand, a compositing process is required to determine which pixels from the source operand are to be emitted based on the values of the pattern operand. For example, referring to FIG. 22a, consider the graphic object 2205. This graphic object may be drawn as shown in FIG. 22b, where:
path is a rectangle 2210,
clip is a rectangle 2220,
operator is the ternary raster operation, 0xCA.
source operand is an image 2230, and
pattern operand is a 1 bpp image 2240 also known as a bit-mask.

The ternary raster operation (ROP3) 0xCA, also known as DPSDxax, indicates that wherever the pattern is 1 (shown as white in image 2240), the source fill is copied to the destination, otherwise where the pattern is 0 (shown as black in image 2240), the destination is left unmodified. In effect, the pattern represents a pixel-array-based shape, which describes an additional region to clip the source fill. By calculating the intersection of the path 2210, clip 2220 and bit-mask 2240, it can be seen that the graphic object could be equivalently rendered according to the path 2260 and image 2270 of FIG. 22c.

For convenience, the pattern is referred to hereafter as the bit-mask and assumes bit 0 refers to the outside of the shape to mask and bit 1 refers to the inside of the shape to mask. Note also that although the 0xCA ROP3 is described, those skilled in the art will know that other ROPs such as 0xAC, 0xE2 and 0xB8 ROP3s or 0xAACC, and 0xCCAA ROP4s that perform a similar clipping operation are easily processed according to the methods described herein.

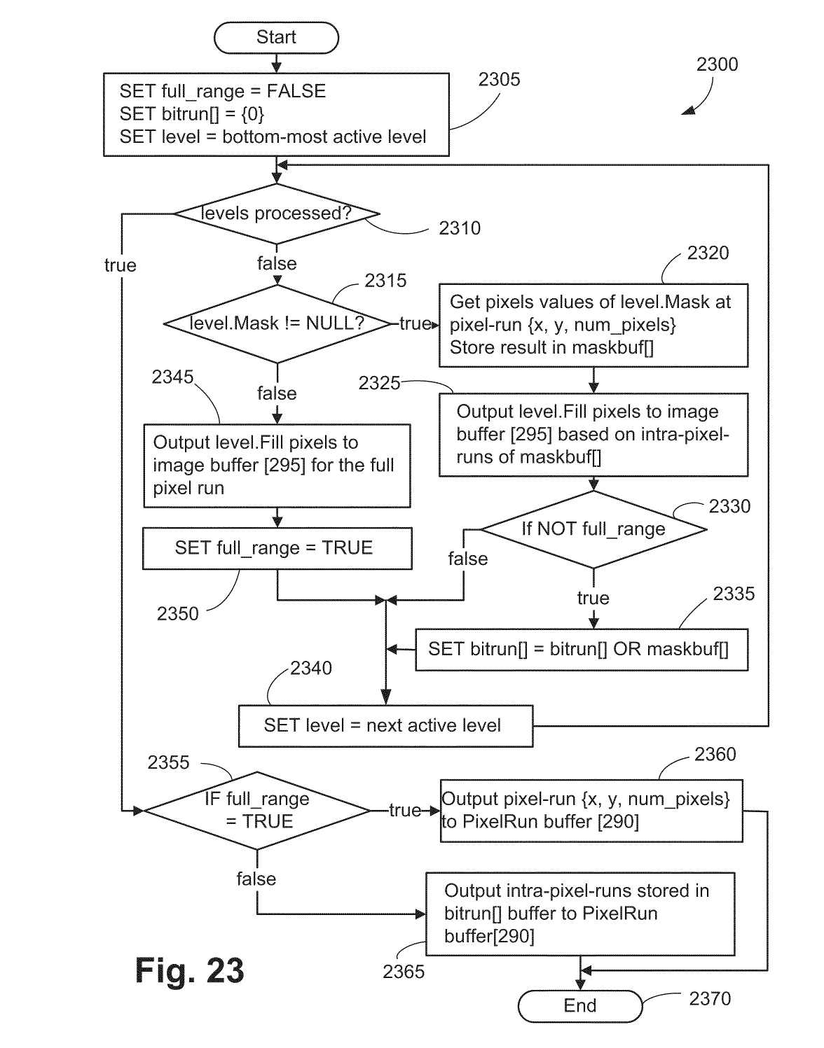

Referring to FIG. 23, a process 2300 describes a unique compositing method, which determines intra-pixel-runs between two edges, taking into account the presence of a bit-mask for each active level. The method 2300 is typically implemented as part of the LiteRIP 1840. Active levels are sorted in increasing Z-order, from bottom-most active level to top-most active level. The method 2300 utilises an intermediate buffer, bitrun, which stores the accumulated 1-bits of any bit-masks associated with an active level, from the bottom-most active-level to the top-most level. During processing of each level, the pixel fill values corresponding to the 1-bits are output to the minimal bit depth buffer 1895, hereafter referred to as the image buffer 1895, overwriting any previously written pixel values. At the end of processing the levels, the accumulated pixel runs, represented by 1-bits, are stored in bitrun. Sequences of 1-bits are then output as “intra-pixel-runs” to the PixelRun buffer 1890.

At step 2305, the variable full range is initialised to FALSE, the bitrun buffer is initialised to zero, and level is set to the bottom-most active level. Execution proceeds to step 2310 where if all active levels have been processed, then execution proceeds to step 2355, otherwise execution proceeds to step 2315. At step 2315 if the current level has an associated bit-mask, execution proceeds to step 2320, otherwise execution proceeds to step 2345. At step 2320, the bits of the bit-mask corresponding to the pixel-run {x, y, num_pixels} are written to the bit-buffer, maskbuf. Execution proceeds to step 2325, where the actual fill-data is written to the image buffer 1895 based on the 1-bits stored in maskbuf. For example, if the pixel-run consisted of ten pixels, num_pixels=10, starting at x=30, on scanline ‘y’, where the bit-mask corresponding to this pixel-run was {1, 0, 0, 1, 1, 1, 0, 0, 1, 1}, then three intra-pixel-runs exist: {30, y, 1}, {33, y, 3}, and {38, y, 2}. If the fill consisted of a flat orange operand, then orange would be written to the image buffer 1895 for each of three afore-mentioned pixel-runs. Execution then proceeds to step 2330. At step 2330, if full_range is false, and there are more levels to process, the execution proceeds to step 2335, otherwise, execution proceeds to step 2340. At step 2335, the bits in maskbuf are added to the bitrun buffer and execution proceeds to step 2340. At step 2340, variable level is set to the next active level. If at step 2315 a level does not have a mask, then execution proceeds to step 2345, where the actual fill data is written to the image buffer 1895 for the full length of the pixel-run. At step 2360, full range is set to true and execution proceeds to step 2340. At step 2310, when all levels have been processed, then at step 2355, if full_range is set to TRUE, then at step 2360, the pixel-run tuple {x, y, num_pixels} is emitted to the PixelRun buffer 1890. Otherwise, at step 2365, the intra-pixel-runs stored in the bitrun buffer are emitted to the PixelRun buffer 1890.

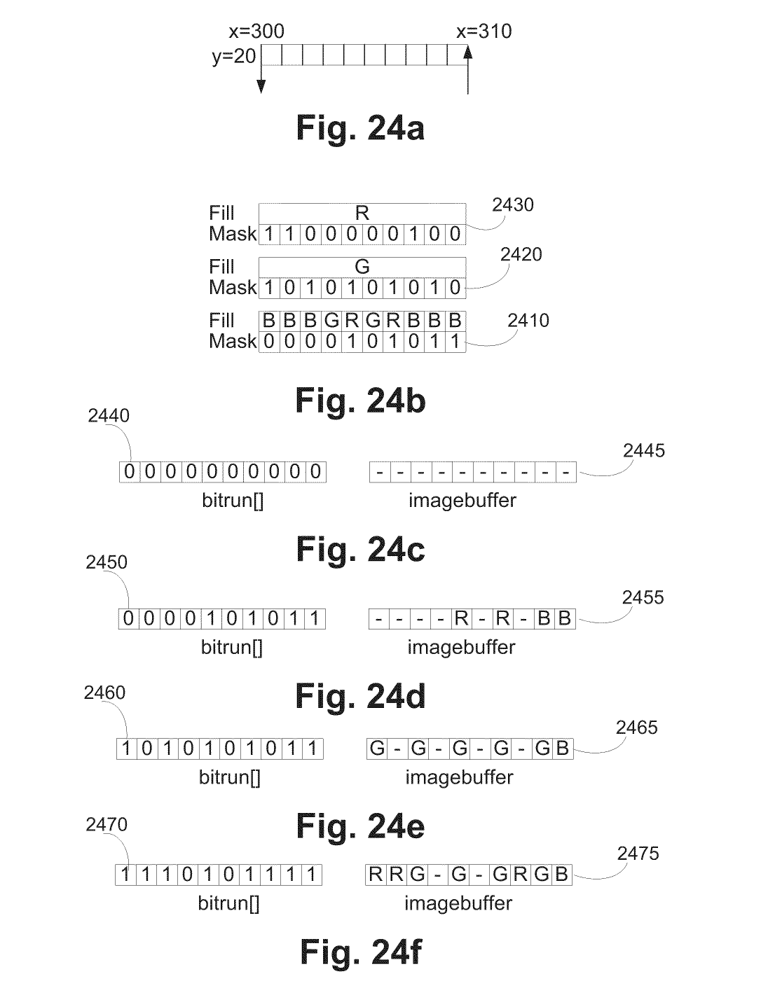

FIG. 24a is a diagram of the pixel-run between edges x=300 and x=310 at scanline 20 of an arbitrary image. The following example executes the process 2300 using three active levels between a pixel-run {x=300, y=20, num_pixels=10}. As shown in FIG. 24b:

(a) level 2430 is the top-most active level, with
(a-i) Fill: {flat red},
(a-ii) Mask: {1, 1, 0, 0, 0, 0, 0, 1, 0, 0}

(b) level 2420 is the active level below level 2 in Z-order, with
(b-i) Fill: {flat green},
(b-ii) Mask: {1, 0, 1, 0, 1, 0, 1, 0, 1, 0}

(c) level 2410 is the bottom-most active level at this pixel-run, with
(c-i) Fill: {image: blue, blue, blue, green, red, green, red, blue, blue, blue}
(c-ii) Mask: {0, 0, 0, 0, 1, 0, 1, 0, 1, 1}.

Beginning at step 2305, full range is set to FALSE, bitrun array is initialised to zero and level points to level 2410. The image buffer 1895 has no pixel values written at the 10-pixel region corresponding to pixel-run {300, 20, 10}. FIG. 24c shows the contents of the bitrun buffer 2440 and image buffer 2445 at pixel-run {300, 20, 10} after initialization.

At step 2310, the levels have not been processed, and at step 2315, level 2410 has a mask. At step 2320, the bits for the mask at the current pixel-run are retrieved in array maskbuf={0, 0, 0, 0, 1, 0, 1, 0, 1, 1}. At step 2325, the pixel values of the fill are output to the image buffer 1895 based on the intra-pixel-runs of maskbuf. In this case, the intra-pixel-runs are:
1. {304, 20, 1}, corresponding to pixel {red}
2. {306, 20, 1}, corresponding to pixel {red}
3. {308, 20, 2}, corresponding to pixels {blue, blue}

At step 730, full_range is false and execution proceeds to step 2335 where bitrun is bitwise OR-ed with maskbuf to become {0, 0, 0, 0, 1, 0, 1, 0, 1, 1}. At step 2340, level is set to the next active level, level 2420. Execution continues to step 2310.

FIG. 24d shows the contents of the bitrun buffer 2450 and image buffer 2455 after processing level 810.

At step 2310, the levels have not been processed, and at step 2315, level 2420 has a mask. At step 2320, the bits for the mask at the current pixel-run are retrieved in array maskbuf={1, 0, 1, 0, 1, 0, 1, 0, 1, 0}. At step 2325, the pixel values of the fill are output to the image buffer 1895 based on the intra-pixel-runs of maskbuf. In this case, the intra-pixel-runs are:
1. {300, 20, 1}, corresponding to pixel {green}
2. {302, 20, 1}, corresponding to pixel {green}
3. {304, 20, 1}, corresponding to pixel {green}
4. {306, 20, 1}, corresponding to pixel {green}
5. {308, 20, 1}, corresponding to pixel {green}

At step 2330, full_range is false and execution proceeds to step 2335 where bitrun is bitwise OR-ed with maskbuf to become {1, 0, 1, 0, 1, 0, 1, 0, 1, 1}. At step 2340, level is set to the next active level, level 2430. Execution continues to step 2310.

FIG. 24e shows the contents of the bitrun buffer 2460 and image buffer 2465 after processing level 2420.

At step 2310, the levels have not been processed, and at step 2315, level 2430 has a mask. At step 2320, the bits for the mask at the current pixel-run are retrieved in array maskbuf={1, 1, 0, 0, 0, 0, 0, 1, 0, 0}. At step 2325, the pixel values of the fill are output to the image buffer 1895 based on the intra-pixel-runs of maskbuf. In this case, the intra-pixel-runs are:
1. {300, 20, 2}, corresponding to pixel {red}
2. {307, 20, 1}, corresponding to pixel {red}

At step 2330, full_range is false and execution proceeds to step 2335 where bitrun is bitwise OR-ed with maskbuf to become {1, 1, 1, 0, 1, 0, 1, 1, 1, 1}. At step 2340, level is set to the next active level, which is NULL. Execution continues to step 2310.

FIG. 24f shows the contents of the bitrun buffer 2470 and image buffer 2475 after processing level 2430.

At step 2310, level is NULL indicating the levels have been processed. Execution proceeds to step 755, where full range is false. At step 2365, the pixel-runs stored in array bitrun are output to the PixelRun buffer 1890. These are:
1. {300, 20, 3}
2. {304, 20, 1}
3. {306, 20, 4}

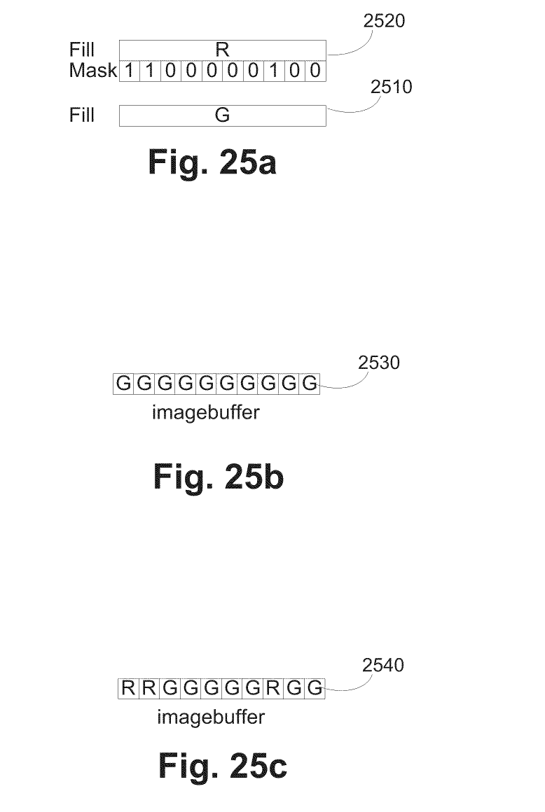

Referring to FIG. 25a, we consider the pixel-run of FIG. 24a, which has two active levels, where:

(a) level 2520 is the top-most active level, with
(a-i) Fill: {flat red},
(a-ii) Mask: {1, 1, 0, 0, 0, 0, 0, 1, 0, 0}

(b) level 2510 is the bottom-most active level, with
(b-i) Fill: {flat green}.

Beginning at step 2305, full_range is set to FALSE, bitrun array is initialised to zero and level points to level 2510. The image buffer 1895 has no pixel values written at the 10-pixel region corresponding to pixel-run {300, 20, 10}.

At step 2310, the levels have not been processed, and at step 2315, level 2510 does not have a mask. At step 2345, the pixel values of the fill are output to the image buffer 1895 based on the full pixel-run. In this case, the pixel-runs is:
1. {300, 20, 10}, corresponding to pixel {green}.

At step 2350, full_range is set to true and execution proceeds to step 2340 where level is set to the next active level, level 2520. Execution continues to step 2310.

FIG. 25b shows the contents of the image buffer 2530 after processing level 2510.

At step 2310, the levels have not been processed, and at step 2315, level 2520 has a mask. At step 2320, the bits for the mask at the current pixel-run are retrieved in array maskbuf={1, 1, 0, 0, 0, 0, 0, 1, 0, 0}. At step 2325, the pixel values of the fill are output to the image buffer 1895 based on the intra-pixel-runs of maskbuf. In this case, the intra-pixel-runs are:
1. {300, 20, 2}, corresponding to pixel {red}
2. {307, 20, 1}, corresponding to pixel {red}.

At step 2330, full_range is true and execution proceeds to step 2340 where level is set to the next active level, which is NULL. Execution continues to step 2310.

FIG. 25c shows the contents of the image buffer 2540 after processing level 2520.

At step 2310, level is NULL indicating the levels have been processed. Execution proceeds to step 2355, where full_range is true. At step 2360, the full pixel-run {300, 20, 10} is output to the PixelRun buffer 1890.

### PixelRun to Path Module

The PixelRun to Path module 1880 of FIG. 18 is responsible for generating a set of edges describing the set of pixel-runs emitted from the LiteRIP module 1840 and stored in the PixelRun buffer 1890. The pixel-run {x, y, num_pixels} is easily represented by the 4-tuple (top, left, width, height) which describes a rectangle. Methods to combine rectangles to generate a path are well known in the art. One such method described in Australian Application Number 2002301567 (Applicant Canon Kabushiki Kaisha, Inventor Smith, David Christopher, Title “A Method of Generating Clip Paths for Graphic Objects”) combines such rectangles, generating a set of edges describing the combined set of rectangles.

Yet other representations and methods are possible to generate the simple path outline from the stream of identified pixel spans. For example, the PixelRun to Path module 1880 may write the pixel-runs directly into a bit-mask buffer. In that case, the Object Processor 1820 constructs a RenderObject where:

(i) the path is a rectangle describing the coalesced image.

(ii) the clip is NULL

(iii) the operator is a ROP3 0xCA operator, requiring a source operand for the pixel data, and a pattern operand for the shape data,

(iv) the source operand is an opaque flat or image operand storing the pixel values of the coalesced image, and

(v) the pattern operand is a bit-mask where 1-bits represent the inside of the coalesced image region and 0-bits represent the outside of the coalesced image region.

### Example

The method 2300 ensures pixel runs emitted to the PixelRun buffer 1890 include any bit-masks present in the LiteDL 1830. The PixelRun to Path module 1880 is therefore able to generate a path which is the union of the intersections of the path, clip and bit-masks of each candidate graphic object 1810. By definition the coalesced graphic object 1860 represents the smallest possible graphic object. More importantly, the coalesced graphic object 1860 can be rendered by a simple COPYPEN operation, instead of the significantly more expensive ternary raster operations required when graphic objects are drawn with source and pattern operands.

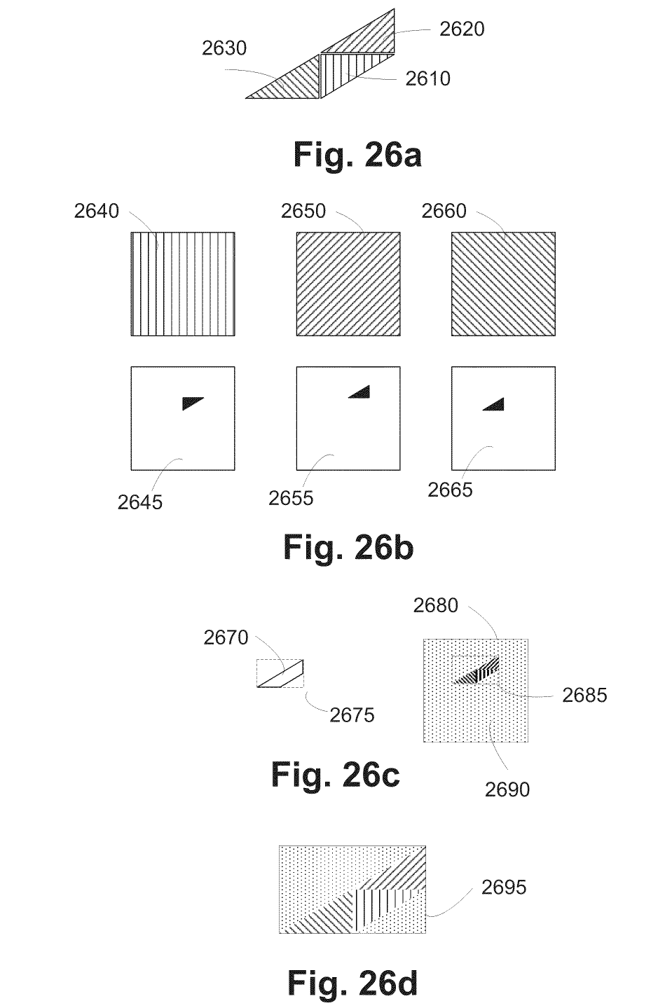

FIG. 26a shows an example page comprising three graphic objects; triangle 2610, triangle 2620 and triangle 2630 forming a trapezoid shape. FIG. 26b shows the three graphic objects represented as source fills and pattern masks, where graphic object 2610 is represented by source image 2640 and pattern mask 2645, graphic object 2620 is represented by source image 2650 and pattern mask 2655 and graphic object 2630 is represented by source image 2660 and pattern mask 2665. The three objects are added to the LiteDL 1830. The Object Processor 1820 then instructs the PixelRun to Path module 1880 to generate a path from the LiteDL 1830 using the LiteRIP module 1840. During rendering, the Minimal bit depth buffer 1895 receives the pixel data and the PixelRun buffer 1890 receives the pixel-runs generated by the process 2300, such that a single coalesced graphic object is generated by Filter module 1770. FIG. 26c shows the coalesced path 2670 generated by PixelRun to Path module 1880 and source fill 2680 generated by LiteRIP module 1840, which consists of fill data from 2640, 2650, 2660 and pre-initialised pixels 2690 which are outside of the coalesced path 2670. Typically before rendering begins, the contents of the image buffer 1895 are initialised to zero.

The coalesced path 2670 and image 2680 are returned to the Object Processor 1820 for sending to the Print Rendering System 1780 as a RenderObject painted with a simple COPYPEN operation. Before emitting the RenderObject, the Object Processor 1820 finally examines the bounding box 2675 of the coalesced path 2670. The bounding box 2675 superimposed over the image 2680 is shown as bounding box 2685 in FIG. 10c. Since no pixels outside bounding box 2685 are required, Object Processor 1820 emits the smaller image 2695 to the Print Rendering System 1780 as shown in FIG. 26d.

If each of source fills 2640, 2650 and 2660 were 20 MB, and each of pattern masks 2645, 2655, 2665 were 800 kB, then without the Filter Module 1770, the Print Rendering System 1780 would need to store over 62 MB of image data, and perform per-pixel compositing for each graphic object as is required when rendering ternary raster operations. Contrast this with a simple graphic object consisting of path 2670 and image 2695 requiring some 30 kB of storage. It can be seen that the presence of Filter Module 1770 in the printing system 1700 significantly reduces the load of the Print Rendering System 1780 in terms of image data storage requirements, image processing time, and CPU load during compositing.

The methods described herein may alternatively be implemented in dedicated hardware such as one or more integrated circuits. Such dedicated hardware may include graphic processors, digital signal processors, or one or more microprocessors and associated memories, which may form part of a graphics engine or graphics rendering system. In particular, the methods described herein may be implemented in an embedded processing core comprising memory and one or more microprocessors.

Some aspects of the present disclosure may be summarized in the following alphabetically labelled paragraphs:

### Dynamic Pipeline

A. In a graphics rendering system, a method of applying idiom recognition processing to incoming graphics objects, where idiom recognition processing is carried out using a processing pipeline, said pipeline having a object-combine operator and a group-removal operator, where the object-combine operator is earlier in the pipeline than the group-removal operator, comprising the steps of:
(i) receiving a sequence of graphics commands comprising of a group start instruction, a first paint object instruction, and a group end instruction;
(ii) modifying said processing pipeline in response to detecting a property of said sequence of graphics commands by relocating the group-removal operator to be earlier in the pipeline stage than the object-combine operator; and
(iii) processing said received first paint object instruction according to the modified processing pipeline.

B. The method according to paragraph A, where a threshold number of a sequence of graphics commands of step (ii) are received before step (iii) is taken.

C. The method according to paragraph A, further comprising the steps of:
(iv) receiving a sequence of graphics commands determined to be incompatible with said modified processing pipeline; and
(v) restoring the processing pipeline to have the object-combine operator earlier in the pipeline than the group-removal operator.

### Merging Overlapping or Proximate Glyphs

D. A method of improving rendering performance by modifying the input drawing commands comprising the steps of:
detecting a first glyph drawing command;
detecting a predetermined number of glyph drawing commands overlapping the first glyph drawing command;
accumulating the predetermined number of overlapping glyph drawing commands;
combining the accumulated overlapping glyph drawing commands into a 1-bit depth bitmap; and
outputting the combined result as a new drawing command.

E. The method according to paragraph D, wherein the first glyph drawing command has an opaque fill pattern and a ROP which does not utilize the background colour.

F. The method according to paragraph D, wherein the overlapping glyph drawing commands operate on an area within a bounding box of the first glyph drawing command enlarged by a predetermined criterion.

G. A method of improving rendering performance by modifying the input drawing commands comprising the steps of:
detecting a first glyph drawing command;
detecting a predetermined number of glyph drawing commands overlapping first glyph drawing command;
allocating 1-bit depth bitmap buffer which has the same size as a bounding box of the first glyph expanded by a predetermined criterion;
combining at least said predetermined number of overlapping glyph drawing commands into allocated 1-bit depth bitmap; and
outputting a result of the combining step as a new drawing command.

H. The method according to paragraph D or G, wherein the combined result is a drawing command comprising at least one of:
(a) a ROP3 0xCA operator; and
(b) a fill-path shape, wherein
   said shape is filled with source=original fill of first glyph, or
   said shape is filled with pattern=the single 1 bpp bitmap mask.

I. The method according to paragraph D or G, wherein the combined result is a drawing command comprising at least one of:
(a) the original ROP of the of the first glyph;
(b) a fill path which trace the “1” bits of the 1-bit depth bitmap; and
(c) source=original fill of first glyph.

### Method of Optimizing a Stream of Graphic Objects

J. A method of simplifying a stream of graphic objects, the method comprising:
(i) receiving two or more graphic objects satisfying a per-object criterion;
(ii) storing said graphic objects in a display list satisfying a coalesced-object criterion;
(iii) generating a combined path outline and a minimal bit-depth operand of said display list; and
(iv) replacing said graphic objects satisfying the per-object criteria with said generated combined path outline and minimal bit-depth operand in said stream of graphic objects.

K. A method according to paragraph I, wherein at least one graphic object stored in said display list has an associated bit-mask.

L. A method according to paragraph K, wherein the combined path outline describes a union of a paint-path, a clip and an associated bit-mask of each graphic object in said display list.

M. A method according to paragraph L, wherein said per-object criterion is a condition that a size of a visible bounding box of the graphic object is less than a pre-determined threshold.

N. A method according to paragraph L, wherein said combined-object criterion is a condition that a size of visible bounding boxes of the union for all graphic objects in the display list is less than a pre-determined threshold.

O. A method according to paragraph L, wherein said minimal bit-depth operand is a flat operand if said display list contains one color.

P. A method according to paragraph L, wherein said minimal bit-depth operand is a one-bit-per-pixel indexed image operand if said display list contains two colors.

Q. A method according to paragraph L, wherein said minimal bit-depth operand is generated by outputting each operand via a corresponding pre-calculated mapping function if said display list contains only at least one flat operand and indexed image operands.

R. A method of simplifying a stream of graphic objects, the method comprising:
(i) receiving two or more graphic objects satisfying per-object criteria;
(ii) storing the graphic objects in a display list satisfying a combined-object criterion, wherein at least one graphic object stored in said display list has an associated bit-mask;
(iii) generating a combined path outline and a minimal bit-depth operand of said display list, wherein said combined path-outline describes a union of the paint-path, clip and associated bit-mask, for each graphic object in said display list; and
(iv) replacing said graphic objects satisfying the per-object criterion with said generated combined path outline and minimal bit-depth operand in said stream of graphic objects.

S. A method for rendering a plurality of graphical objects of an image on a scanline basis, each scanline comprising at least one run of pixels, each run of pixels being associated with at least one of the graphical objects such that the pixels of the run are within the edges of the at least one graphical object, said method comprising:
(i) decomposing each of the graphical objects into at least one edge representing the corresponding graphical objects;
(ii) sorting one or more arrays containing the edges representing the graphical objects of the image, at least one of the arrays being sorted in an order from a highest priority graphical object to a lowest priority graphical object;
(iii) determining at least one edge of the graphical objects defining a run of pixels of a scanline, at least one graphical objects contributing to the run and at least one edge of the contributing graphical objects, using the arrays; and
(iv) generating the run of pixels by outputting, if the highest priority contributing graphical object is opaque,
   (i) a set of pixel data within the edges of the highest priority contributing graphical object to an image buffer; and
   (ii) a set of pixel-run tuples {x, y, num_pixels} to a pixel-run buffer;

otherwise,
(i) compositing a set of pixel data to an image buffer, and bit-wise OR-ing a set of bit-mask data onto a bit-run buffer, the set of pixel data and the set of bit-mask data associated with the highest priority contributing graphical object and one or more of further contributing graphical objects, and
(ii) emitting the composited bit-run buffer as a set of pixel-run tuples {x, y, num_pixels} to a pixel-run buffer for each sequence of 1-bits in the bit-run buffer, relative to the run-of-pixels.

The foregoing describes only some embodiments of the present invention, and modifications and/or changes can be made thereto without departing from the scope and spirit of the invention, the embodiments being illustrative and not restrictive.

We claim:

1. A method of modifying drawing commands to be input to a rendering process, the method comprising:
detecting a first glyph drawing command;
detecting a predetermined number of further glyph drawing commands proximate within a threshold of the first glyph drawing command;
accumulating the predetermined number of proximate glyph drawing commands;
combining the accumulated proximate glyph drawing commands into a 1-bit depth bitmap; and
outputting the 1-bit depth bitmap to the rendering process as a new drawing command.

2. A method according to claim 1 wherein the further glyph drawing commands include drawing commands that overlap the first glyph drawing command.

3. The method according to claim 1, wherein the first glyph drawing command has an opaque fill pattern and a raster operation (ROP) which does not utilize the background colour.

4. The method according to claim 1, wherein the proximate glyph drawing commands operate on an area within a bounding box of the first glyph drawing command enlarged by a predetermined criterion.

5. The method according to claim 4 wherein the predetermined criterion is determined by experimentation and expands the bounding box by four hundred pixels.

6. The method of claim 1 wherein the new drawing command comprises one of:
A. (Aa) the 1-bit depth bitmap;
(Ab) a ROP3 0xCA operator; and
(Ac) a fill-path shape, wherein said shape is filled with an original fill of the combined glyphs; and
B. (Ba) the original ROP of the first glyph;
(Bb) a fill path which traces the “1” bits of the 1-bit depth bitmap; and
(Bc) an original fill of the combined glyphs.

7. A computer implemented method of modifying drawing commands to be input to a rendering process, the method comprising:
detecting a first drawing command for a first glyph;
detecting a predetermined number of drawing commands for further glyphs proximate the first glyph;
allocating 1-bit depth bitmap buffer which has the same size as a bounding box of the first glyph expanded by a predetermined criterion such that the expanded bounding box includes the first glyph and the proximate further glyphs;
combining the first drawing command and the at least said predetermined number of the proximate glyph drawing commands into the allocated 1-bit depth bitmap; and
outputting a new drawing command to the rendering process, the new drawing command comprises one of:
A. (Aa) the 1-bit depth bitmap;
(Ab) a ROP3 0xCA operator; and
(Ac) a fill-path shape, wherein said shape is filled with an original fill of the combined glyphs; and
B. (Ba) the original ROP of the first glyph;
(Bb) a fill path which traces the “1” bits of the 1-bit depth bitmap; and
(Bc) an original fill of the combined glyphs.

8. A method of merging glyphs in a graphic object stream to be input to a rendering process, the method comprising:
detecting, in the graphic object stream, a sequence of at least a predetermined number (N) of spatially proximate glyph graphic objects; and
merging the detected spatially proximate glyph graphic objects from the predetermined Nth spatially proximate glyph graphic object to a last spatially proximate glyph graphic object of the sequence into a 1-bit depth bitmap mask, the merging replacing the detected spatially proximate glyph graphic objects from the predetermined Nth spatially proximate glyph graphic object to the last detected spatially proximate glyph graphic object with:
a single graphic object determined using:
ROP3 0xCA with original source fill pattern,
a rectangle fill path shape, and
the generated 1-bit depth bitmap mask; or
a single graphic object determined using:
original ROP of the detected glyph graphic object; and
a fill path which describes a trace ‘1’ bit of the generated 1-bit depth bitmap mask.

9. The method of claim 7 wherein the glyphs are described by different object types selected from the group consisting of vector graphics, bitmaps, and wherein the combining combines the different object types, and the different object types are output with a single ROP4 or multiple ternary operators as part of the new drawing command.

10. The method claim 9, wherein the output operator is simplified if any ROP3 patterns, being a ternary operator are determined to be all zero.

11. A method of processing a stream of drawing commands to be input to a rendering process, said method comprising:
performing trend analysis on the stream to identify a plurality of consecutive glyph drawing commands having a determinable spatial proximity;
in response to the identification, combining the spatially proximate drawing commands to form a new drawing command; and
incorporating the new drawing command into the stream to the rendering process.

12. A method according to claim 11 wherein the trend analysis identifies an initial predetermined number (N) of spatially proximate drawing command from the stream and the combining operates upon consecutive subsequent spatially proximate drawing commands from the stream.

13. A method according claim 12 further comprising determining a trend analysis threshold through statistical observation of the drawing commands, the threshold establishing the plurality of commands.

14. A method according to claim 13 wherein the statistical observation is performed upon a range of streams of drawing commands and is then set for application in the method to a further stream of drawing commands.

15. A method according to claim 14 wherein the trend analysis examines the stream of drawing commands statistically and dynamically adjusts the trend analysis threshold to set the plurality of drawing commands having spatial proximity to be identified before enabling the combining of drawing commands.

16. A method according to claim 12 wherein the trend analysis further comprises:
establishing a plurality of threshold proximity bounding boxes each with a corresponding threshold and corresponding to a different object type in response to the stream of drawing commands; and
identifying a threshold number of objects of a particular object type in the corresponding bounding box to enable the combining of those identified objects.

17. A method according to claim 12, wherein the trend analysis further comprises identifying a threshold number of objects in a threshold proximity bounding box to enable the combining of those object.

18. A system for modifying drawing commands to be input to a rendering process, the system comprising:
a memory for storing data and a computer program;
a processor coupled to said memory for executing said computer program, said computer program comprising instructions for:
detecting a first glyph drawing command;
detecting a predetermined number of further glyph drawing commands proximate within a threshold of the first glyph drawing command;
accumulating the predetermined number of proximate glyph drawing commands;
combining the accumulated proximate glyph drawing commands into a 1-bit depth bitmap; and
outputting the 1-bit depth bitmap to the rendering process as a new drawing command.

19. A system for modifying drawing commands to be input to a rendering process, the system comprising:
a memory for storing data and a computer program;
a processor coupled to said memory for executing said computer program, said computer program comprising instructions for:
detecting a first drawing command for a first glyph;
detecting a predetermined number of drawing commands for further glyphs proximate the first glyph;
allocating 1-bit depth bitmap buffer which has the same size as a bounding box of the first glyph expanded by a predetermined criterion such that the expanded bounding box includes the first glyph and the proximate further glyphs;
combining the first drawing command and the at least said predetermined number of the proximate glyph drawing commands into the allocated 1-bit depth bitmap; and
outputting a new drawing command to the rendering process, the new drawing command comprises one of:
A. (Aa) the 1-bit depth bitmap;
(Ab) a ROP3 0xCA operator; and
(Ac) a fill-path shape, wherein said shape is filled with an original fill of the combined glyphs; and
B. (Ba) the original ROP of the first glyph;
(Bb) a fill path which traces the “1” bits of the 1-bit depth bitmap; and
(Bc) an original fill of the combined glyphs.

20. A system for merging glyphs in a graphic object stream to be input to a rendering process, the system comprising:
a memory for storing data and a computer program;
a processor coupled to said memory for executing said computer program, said computer program comprising instructions for:
detecting, in the graphic object stream, a sequence of at least a predetermined number (N) of spatially proximate glyph graphic objects; and
merging the detected spatially proximate glyph graphic objects from the predetermined Nth spatially proximate glyph graphic object to a last spatially proximate glyph graphic object of the sequence into a 1-bit depth bitmap mask, the merging replacing the detected spatially proximate glyph graphic objects from the predetermined Nth spatially proximate glyph graphic object to the last detected spatially proximate glyph graphic object with:
a single graphic object determined using:
ROP3 0xCA with original source fill pattern,
a rectangle fill path shape, and
the generated 1-bit depth bitmap mask; or
a single graphic object determined using:
original ROP of the detected glyph graphic object; and
a fill path which describes a trace ‘1’ bit of the generated 1-bit depth bitmap mask.

21. A system for processing a stream of drawing commands to be input to a rendering process, said system comprising:
a memory for storing data and a computer program;
a processor coupled to said memory for executing said computer program, said computer program comprising instructions for:
performing trend analysis on the stream to identify a plurality of consecutive glyph drawing commands having a determinable spatial proximity;
in response to the identification, combining the spatially proximate drawing commands to form a new drawing command; and
incorporating the new drawing command into the stream to the rendering process.

22. An apparatus for modifying drawing commands to be input to a rendering process, the apparatus comprising:
means for detecting a first glyph drawing command;
means for detecting a predetermined number of further glyph drawing commands proximate within a threshold of the first glyph drawing command;
means for accumulating the predetermined number of proximate glyph drawing commands;
means for combining the accumulated proximate glyph drawing commands into a 1-bit depth bitmap; and
means for outputting the 1-bit depth bitmap to the rendering process as a new drawing command.

23. An apparatus for modifying drawing commands to be input to a rendering process, the apparatus comprising:
means for detecting a first drawing command for a first glyph;
means for detecting a predetermined number of drawing commands for further glyphs proximate the first glyph;
means for allocating 1-bit depth bitmap buffer which has the same size as a bounding box of the first glyph expanded by a predetermined criterion such that the expanded bounding box includes the first glyph and the proximate further glyphs;
means for combining the first drawing command and the at least said predetermined number of the proximate glyph drawing commands into the allocated 1-bit depth bitmap; and
means for outputting a new drawing command to the rendering process, the new drawing command comprises one of:
A. (Aa) the 1-bit depth bitmap;
(Ab) a ROP3 0xCA operator; and
(Ac) a fill-path shape, wherein said shape is filled with an original fill of the combined glyphs; and
B. (Ba) the original ROP of the first glyph;
(Bb) a fill path which traces the “1” bits of the 1-bit depth bitmap; and
(Bc) an original fill of the combined glyphs.

24. An apparatus for merging glyphs in a graphic object stream to be input to a rendering process, the apparatus comprising:
means for detecting, in the graphic object stream, a sequence of at least a predetermined number (N) of spatially proximate glyph graphic objects; and
means for merging the detected spatially proximate glyph graphic objects from the predetermined Nth spatially proximate glyph graphic object to a last spatially proximate glyph graphic object of the sequence into a 1-bit depth bitmap mask, the merging replacing the detected spatially proximate glyph graphic objects from the predetermined Nth spatially proximate glyph graphic object to the last detected spatially proximate glyph graphic object with:
a single graphic object determined using:
ROP3 0xCA with original source fill pattern,
a rectangle fill path shape, and
the generated 1-bit depth bitmap mask; or
a single graphic object determined using:
original ROP of the detected glyph graphic object; and
a fill path which describes a trace ‘1’ bit of the generated 1-bit depth bitmap mask.

25. An apparatus for processing a stream of drawing commands to be input to a rendering process, said apparatus comprising:
means for performing trend analysis on the stream to identify a plurality of consecutive glyph drawing commands having a determinable spatial proximity and in response to the identification, combining the spatially proximate drawing commands to form a new drawing command; and
means for incorporating the new drawing command into the stream to the rendering process.

26. A computer readable storage medium having a computer program recorded therein, the program being executable by a computer apparatus to make the computer perform a method of modifying drawing commands to be input to a rendering process, said program comprising:
code for detecting a first glyph drawing command;
code for detecting a predetermined number of further glyph drawing commands proximate within a threshold of the first glyph drawing command;
code for accumulating the predetermined number of proximate glyph drawing commands;
code for combining the accumulated proximate glyph drawing commands into a 1-bit depth bitmap; and
code for outputting the 1-bit depth bitmap to the rendering process as a new drawing command.

27. A computer readable storage medium having a computer program recorded therein, the program being executable by a computer apparatus to make the computer perform a method of modifying drawing commands to be input to a rendering process, said program comprising:
code for detecting a first drawing command for a first glyph;
code for detecting a predetermined number of drawing commands for further glyphs proximate the first glyph;
code for allocating 1-bit depth bitmap buffer which has the same size as a bounding box of the first glyph expanded by a predetermined criterion such that the expanded bounding box includes the first glyph and the proximate further glyphs;
code for combining the first drawing command and the at least said predetermined number of the proximate glyph drawing commands into the allocated 1-bit depth bitmap; and
code for outputting a new drawing command to the rendering process, the new drawing command comprises one of:
A. (Aa) the 1-bit depth bitmap;
(Ab) a ROP3 0xCA operator; and
(Ac) a fill-path shape, wherein said shape is filled with an original fill of the combined glyphs; and
B. (Ba) the original ROP of the first glyph;
(Bb) a fill path which traces the “1” bits of the 1-bit depth bitmap; and
(Bc) an original fill of the combined glyphs.

28. A computer readable storage medium having a computer program recorded therein, the program being executable by a computer apparatus to make the computer perform a method of merging glyphs in a graphic object stream to be input to a rendering process, said program comprising:
code for detecting, in the graphic object stream, a sequence of at least a predetermined number (N) of spatially proximate glyph graphic objects; and
code for merging the detected spatially proximate glyph graphic objects from the predetermined Nth spatially proximate glyph graphic object to a last spatially proximate glyph graphic object of the sequence into a 1-bit depth bitmap mask, the merging replacing the detected spatially proximate glyph graphic objects from the predetermined Nth spatially proximate glyph graphic object to the last detected spatially proximate glyph graphic object with:
a single graphic object determined using:
ROP3 0xCA with original source fill pattern,
a rectangle fill path shape, and
the generated 1-bit depth bitmap mask; or
a single graphic object determined using:
original ROP of the detected glyph graphic object; and
a fill path which describes a trace ‘1’ bit of the generated 1-bit depth bitmap mask.

29. A computer readable storage medium having a computer program recorded therein, the program being executable by a computer apparatus to make the computer perform a method of processing a stream of drawing commands to be input to a rendering process, said program comprising:
code for performing trend analysis on the stream to identify a plurality of consecutive glyph drawing commands having a determinable spatial proximity and in response to the identification, combining the spatially proximate drawing commands to form a new drawing command; and
code for incorporating the new drawing command into the stream to the rendering process.
